(19) United States
(12) Patent Application Publication
(10) Pub. No.: US 2002/0135815 A1
(43) Pub. Date: Sep. 26, 2002

(54) Hand-held scanner with impulse radio wireless interface

(75) Inventor: James S. Finn, Huntsville, AL (US)

Correspondence Address: William J. Tucker, Esq., #2825, 8650 Southwestern Blvd., Dallas, TX, 75206-2688, US

(73) Assignee: Time Domain Corporation

(21) Appl. No.: 09/767,244

(22) Filed: Jan. 22, 2001

(51) Int. Cl. H04N 1/024

(52) U.S. Cl. 358/473

(57) ABSTRACT

A scanner for reading characters from a string of characters recorded on a surface as well as reading bar code information encoded in bar codes. Upon obtaining either the text or the bar code information, the information is transferred to a remote location via impulse radio wireless techniques. The character or bar code scanner may include a lens of variable magnification so as to accommodate variable size print. The scanner is in communication with an external information processing apparatus such as a computer through an impulse radio wireless transmitter/receiver. The value of each pixel detected by the scanner is determined by comparing the light reflection value with a threshold that is adjusted in accordance with the values of pixels detected and averaged over previous frames. The hand-held scanner and impulse radio transceiver and impulse radio antenna may be housed in any elongate housing for pen-like use or in a palm-held housing such as a typical mouse. The novel impulse radio wireless interface allows large data throughput while avoiding many traditional wireless shortfalls such as multipath and RF and optical interference. Distance determination by impulse radio means provides for varying the data rates of the communication between the impulse radio and a remote device based on said distance and allows for a warning that the distance from said remote device to said scanner is exceeding a predetermined limit.

### BACKGROUND OF THE INVENTION

1. Field of the Invention

The invention relates generally to hand-held scanners and other data-input devices, and more specifically to hand-held scanners for scanning text and transmitting the information to an information processing apparatus through wireless means. Still more particularly the present invention relates to transmitting the information to an information processing apparatus through an impulse radio wireless means for significant system improvements.

2. Description of Related Art

Scanners have proliferated in recent years and are now used in countless activities. Further, hand-held scanners have been developed due to the need for portability and ease of use. Numerous hand-held scanners have been developed including U.S. Pat. No. 5,574,804 (Olschafskie et al.) with various attribute improvements. In the '804 patent the improvement lies in the ability to scan multiple lines in text using multiple windows enabling the viewing of the text as scanned; and the ability to incorporate voice recording within the device. Additionally, U.S. Pat. No. 4,800,444 (Suzuki et al.) discloses the use of the scanner with an optical window on the side of the device that faces the user. The user is required to aim the device, held sideways, along the character string while simultaneously viewing the material under the device in the optical window. U.S. Pat. No. 5,012,349 (deFay) discloses a scanner with an LCD panel fitted into the handle. This device must be preset for narrow character heights and rolled sideways directly over the character string. U.S. Pat. No. 3,541,248 (Young) discloses the use of a magnifying member on the scanner. Here, not only must the user view two areas including the window and the character string on a paper, but also the user will experience distortion of the optically viewed materials. U.S. Pat. No. 4,947,261 (Ishikawa et al.) discloses a scanner that should be held vertically over the characters in order to read them into the scanner. No assistance is provided for viewing the material beneath the scanner. The scanner may be equipped with interchangeable lenses having different focal lengths for achieving various magnifications. U.S. Pat. No. 5,083,218 (Takasu et al.) discloses another scanner that is held vertically over the characters to be scanned.

The shortfall of all of the above enumerated scanners is method by which the information can be transmitted from the portable device to a remote location—if this function is provided at all. U.S. Pat. No. 5,574,804 (Olschafskie et al.) discloses a hand-held scanner that enables the transfer of information obtained from scanning to a computer by either wireless or wired means. However, the conventional wireless means used in the '804 patent are traditional wireless communication methods and are therefore dramatically limited. Traditional wireless communication methods including RF and infrared which are contemplated in the '804 patent are plagued by problems; including inter alia Raleigh fading, multipath propagation problems and bandwidth and range constraints as well as obstruction problems and line of sight requirements. Further, traditional wireless communication methods cannot effectively provide distance determination. This wireless transfer of the information is not only a problem in the text scanning apparatuses described in the above patents, but it is also a problem in the numerous bar code scanners in use today.

Thus, there is a need in the art to provide a system allowing for the wireless communication between a scanner and an information processing device such as a computer using an improved wireless means which overcomes the shortcomings of existing wireless technologies and existing positioning technologies.

### BRIEF DESCRIPTION OF THE INVENTION

It is an object of the present invention to provide a hand-held scanner with an impulse radio interface for impulse radio wireless communication to an information processing apparatus. The hand-held scanner reads characters from a string of characters recorded on most mediums or reads bar codes from a bar coding system and transmits this information in impulse radio signals to the information processing apparatus. The housing of the scanner is shaped so that it may be held like a pen and conveniently moved, in contact with the medium, along the medium so as to scan the string of characters or bar code. Further, the housing accommodates the impulse radio transceiver, the impulse radio interface as well as an impulse radio antenna. Movement of the scanner across the surface of the medium is sensed by a sensor. An optical system, located within the housing, uses a small area of the medium and an optical detector detects the relative intensity of light reflected from each of several points in the area of view. The area of view is advantageously clearly visible to the user and unobstructed by the scanner while being used for scanning. The string of characters adjacent to the area of view is also clearly visible while using the scanner of the invention.

In order to achieve the above object, according to a preferred embodiment of the present invention, there is disclosed a scanner with an impulse radio interface that communicates the multiple inputs of information to an information processing apparatus. For example, a microphone mounted on the hand-held scanner converts voice and other sound signals into electrical signals for recording and transmission via impulse radio means to an information processing apparatus. The scanner may also be provided with a wide area scanner that can be used for scanning an entire page, whereafter the information is transferred by impulse radio means to an information processing apparatus. The wide-area scanner may be a four-inch scanner stored in the handle of the hand-held scanner which is used by placing the scanner sideways on the medium and scanning over the page line by line. Further, if desired the impulse radio interface and impulse radio transceiver can be placed within the handle of the scanner.

Another embodiment of the scanner of the present invention includes an addition in optics for producing two images encompassing one area of view. This may be accomplished with an image splitter which preferably rotates the two images with respect to one another. The optical detector generates electrical signals in response to each of the two images. By applying optical character recognition software to the two images in a host computer, the reliability of character recognition is improved. Instead of using a wheel to track the position of the scanner along the surface, a ball rotatably mounted in the housing may be used to provide movement information in two directions. While only one direction is needed for scanning a horizontal line of characters, the scanner can be advantageously switched into a mouse mode for controlling the movement of a cursor on a host computer.

A further embodiment of the invention includes an automatically adjustable threshold for distinguishing between the medium and the characters on the medium. The intensity threshold is continuously reset in response to the relative intensities of light detected in the plurality of points in the area of view of the scanner. A still further embodiment of the invention includes the use of an optical lens with an adjustable magnification. This permits the user to zoom in on small print as the medium is being scanned. Again, the information obtained is transferred to an information processing apparatus via impulse radio means. A final object of the present invention includes the ability to use the optical means to obtain information encoded in bar codes, whereafter the information is transferred to a remote device by impulse radio means. Regarding the transfer, using the positioning capabilities of impulse radio technology alerts can be given and data transfer rates can be varied in response to the distance from the hand-held scanner to the remote processing device.

Other objects and advantages will become apparent during the following description of the presently preferred embodiment of the present invention.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A illustrates a representative Gaussian Monocycle waveform in the time domain.

FIG. 1B illustrates the frequency domain amplitude of the Gaussian Monocycle of FIG. 1A.

FIG. 2A illustrates a pulse train comprising pulses as in FIG. 1A.

FIG. 2B illustrates the frequency domain amplitude of the waveform of FIG. 2A.

FIG. 3 illustrates the frequency domain amplitude of a sequence of time coded pulses.

FIG. 4 illustrates a typical received signal and interference signal.

FIG. 5A illustrates a typical geometrical configuration giving rise to multipath received signals.

FIG. 5B illustrates exemplary multipath signals in the time domain.

FIGS. 5C-5E illustrate a signal plot of various multipath environments.

FIGS. 5F illustrates the Rayleigh fading curve associated with non-impulse radio transmissions in a multipath environment.

FIG. 5G illustrates a plurality of multipaths with a plurality of reflectors from a transmitter to a receiver.

FIG. 5H graphically represents signal strength as volts vs. time in a direct path and multipath environment.

FIG. 6 illustrates a representative impulse radio transmitter functional diagram.

FIG. 7 illustrates a representative impulse radio receiver functional diagram.

FIG. 8A illustrates a representative received pulse signal at the input to the correlator.

FIG. 8B illustrates a sequence of representative impulse signals in the correlation process.

FIG. 8C illustrates the output of the correlator for each of the time offsets of FIG. 8B.

FIG. 9 is a general view of a hand-held scanner of the invention being used to scan a line of text.

FIG. 10 is an isometric view of the hand-held scanner of the invention.

FIG. 11 is a cut-away view of the door on the handle of the scanner of FIG. 10.

FIG. 12 is a partial isometric bottom view of the front end of the scanner of FIG. 10.

FIG. 13 is a cut-away view of the scanner of FIG. 10 illustrating the components relative to the optical scanner at the front tip of the hand-held scanner.

FIG. 14 is a cut-away view of the scanner of FIG. 10 emphasizing the long scanner mounted behind the door of the scanner in FIG. 10.

FIG. 15 is a diagram illustrating the production of two images for detection by the optical detector of a scanner of the invention.

FIG. 16 is a block diagram of the functional components of the scanner of FIG. 10.

FIG. 17 is a more detailed block diagram illustrating the optical detector system and the movement sensor of the invention.

FIG. 18 is an electrical schematic of a threshold setting circuit of the scanner of the present invention.

FIG. 19 is an isometric view of an alternate embodiment of a hand-held scanner of the present invention.

FIG. 20 is a bottom isometric view of the hand-held scanner of FIG. 19.

FIG. 21 is an illustration of the bar code scanner embodiment of the present invention in order to monitor packages or other inventory.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in art. Like numbers refer to like elements throughout.

Recent advances in communications technology have enabled an emerging, revolutionary ultra wideband technology (UWB) called impulse radio communications systems (hereinafter called impulse radio). To better understand the benefits of impulse radio to the present invention, the following review of impulse radio follows. Impulse radio was first fully described in a series of patents, including U.S. Pat. Nos. 4,641,317 (issued Feb. 3, 1987), U.S. Pat. No. 4,813,057 (issued Mar. 14, 1989); U.S. Pat. No. 4,979,186 (issued Dec. 18, 1990) and U.S. Pat. No. 5,363,108 (issued Nov. 8, 1994) to Larry W. Fullerton. A second generation of impulse radio patents includes U.S. Pat. No. 5,677,927 (issued Oct. 14, 1997), U.S. Pat. No. 5,687,169 (issued Nov. 11, 1997) and co-pending application Ser. No. 08/761,602 (filed Dec. 6, 1996) to Fullerton et al.

Uses of impulse radio systems are described in U.S. patent application Ser. No. 09/332,502, entitled, “System and Method for Intrusion Detection using a Time Domain Radar Array” and U.S. patent application Ser. No. 09/332,503, entitled, “Wide Area Time Domain Radar Array” both filed on Jun. 14, 1999 and both of which are assigned to the assignee of the present invention. All of the above patent documents are incorporated herein by reference.

### Impulse Radio Basics

Impulse radio refers to a radio system based on short, low duty cycle pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Most waveforms with enough bandwidth approximate a Gaussian shape to a useful degree.

Impulse radio can use many types of modulation, including AM, time shift (also referred to as pulse position) and M-ary versions. The time shift method has simplicity and power output advantages that make it desirable. In this document, the time shift method is used as an illustrative example.

In impulse radio communications, the pulse-to-pulse interval can be varied on a pulse-by-pulse basis by two components: an information component and a code component. Generally, conventional spread spectrum systems employ codes to spread the normally narrow band information signal over a relatively wide band of frequencies. A conventional spread spectrum receiver correlates these signals to retrieve the original information signal. Unlike conventional spread spectrum systems, in impulse radio communications codes are not needed for energy spreading because the monocycle pulses themselves have an inherently wide bandwidth. Instead, codes are used for channelization, energy smoothing in the frequency domain, resistance to interference, and reducing the interference potential to nearby receivers.

The impulse radio receiver is typically a direct conversion receiver with a cross correlator front end which coherently converts an electromagnetic pulse train of monocycle pulses to a baseband signal in a single stage. The baseband signal is the basic information signal for the impulse radio communications system. It is often found desirable to include a subcarrier with the baseband signal to help reduce the effects of amplifier drift and low frequency noise. The subcarrier that is typically implemented alternately reverses modulation according to a known pattern at a rate faster than the data rate. This same pattern is used to reverse the process and restore the original data pattern just before detection. This method permits alternating current (AC) coupling of stages, or equivalent signal processing to eliminate direct current (DC) drift and errors from the detection process. This method is described in detail in U.S. Pat. No. 5,677,927 to Fullerton et al.

In impulse radio communications utilizing time shift modulation, each data bit typically time position modulates many pulses of the periodic timing signal. This yields a modulated, coded timing signal that comprises a train of pulses for each single data bit. The impulse radio receiver integrates multiple pulses to recover the transmitted information.

### Waveforms

Impulse radio refers to a radio system based on short, low duty cycle pulses. In the widest bandwidth embodiment, the resulting waveform approaches one cycle per pulse at the center frequency. In more narrow band embodiments, each pulse consists of a burst of cycles usually with some spectral shaping to control the bandwidth to meet desired properties such as out of band emissions or in-band spectral flatness, or time domain peak power or burst off time attenuation.

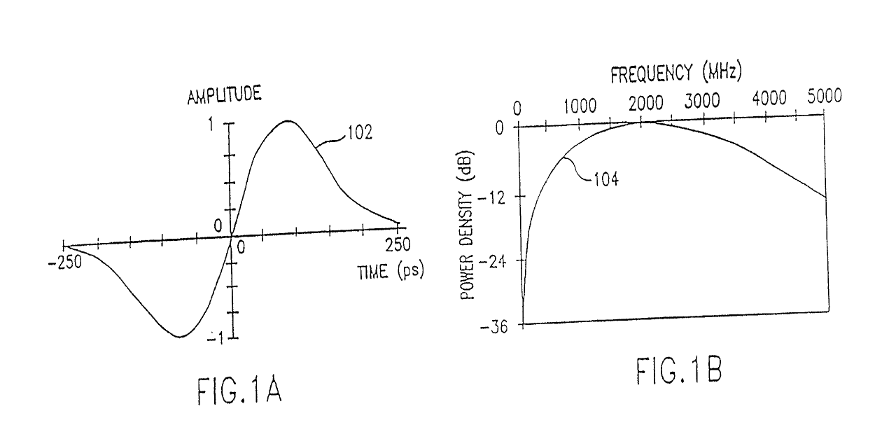

For system analysis purposes, it is convenient to model the desired waveform in an ideal sense to provide insight into the optimum behavior for detail design guidance. One such waveform model that has been useful is the Gaussian monocycle as shown in FIG. 1A. This waveform is representative of the transmitted pulse produced by a step function into an ultra-wideband antenna. The basic equation normalized to a peak value of 1 is as follows:

$${f}_{mono} ( t ) = \sqrt{ⅇ} ( \frac{t}{σ} ) {ⅇ}^{\frac{- {t}^{2}}{2 {σ}^{2}}}$$

Where,

σ is a time scaling parameter,

t is time,

fₘₒₙₒ(t) is the waveform voltage, and

e is the natural logarithm base.

The frequency domain spectrum of the above waveform is shown in FIG. 1B. The corresponding equation is:

Fₘₒₙₒ(ƒ)=(2π)^{3/2}σƒe^{-2(πσƒ)2}

The center frequency (f_{c}), or frequency of peak spectral density is:

$${f}_{c} = \frac{1}{2 πσ}$$

These pulses, or bursts of cycles, may be produced by methods described in the patents referenced above or by other methods that are known to one of ordinary skill in the art. Any practical implementation will deviate from the ideal mathematical model by some amount. In fact, this deviation from ideal may be substantial and yet yield a system with acceptable performance. This is especially true for microwave implementations, where precise waveform shaping is difficult to achieve. These mathematical models are provided as an aid to describing ideal operation and are not intended to limit the invention. In fact, any burst of cycles that adequately fills a given bandwidth and has an adequate on-off attenuation ratio for a given application will serve the purpose of this invention.

### A Pulse Train

Impulse radio systems can deliver one or more data bits per pulse; however, impulse radio systems more typically use pulse trains, not single pulses, for each data bit. As described in detail in the following example system, the impulse radio transmitter produces and outputs a train of pulses for each bit of information.

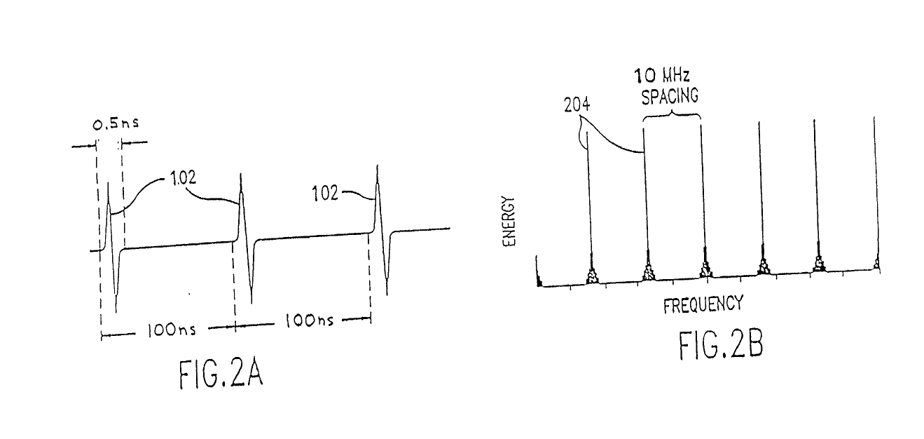

Prototypes have been built which have pulse repetition frequencies including 0.7 and 10 megapulses per second (Mpps, where each megapulse is 10⁶ pulses). FIGS. 2A and 2B are illustrations of the output of a typical 10 Mpps system with uncoded, unmodulated, 0.5 nanosecond (ns) pulses 102. FIG. 2A shows a time domain representation of this sequence of pulses 102. FIG. 2B, which shows 60 MHZ at the center of the spectrum for the waveform of FIG. 2A, illustrates that the result of the pulse train in the frequency domain is to produce a spectrum comprising a set of lines 204 spaced at the frequency of the 10 Mpps pulse repetition rate. When the full spectrum is shown, the envelope of the line spectrum follows the curve of the single pulse spectrum 104 of FIG. 1B. For this simple uncoded case, the power of the pulse train is spread among roughly two hundred comb lines. Each comb line thus has a small fraction of the total power and presents much less of an interference problem to a receiver sharing the band.

It can also be observed from FIG. 2A that impulse radio systems typically have very low average duty cycles resulting in average power significantly lower than peak power. The duty cycle of the signal in the present example is 0.5%, based on a 0.5 ns pulse in a 100 ns interval.

### Coding for Energy Smoothing and Channelization

For high pulse rate systems, it may be necessary to more finely spread the spectrum than is achieved by producing comb lines. This may be done by non-uniformly positioning each pulse relative to its nominal position according to a code such as a pseudo random code.

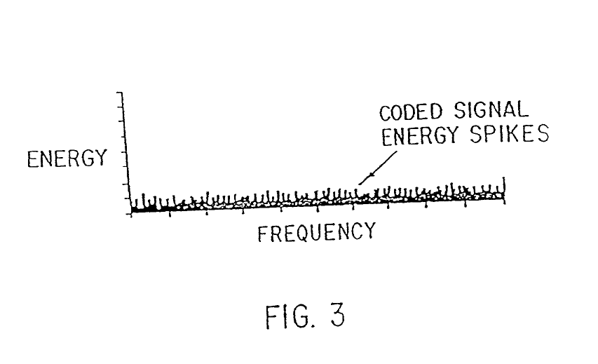

FIG. 3 is a plot illustrating the impact of a pseudo-noise (PN) code dither on energy distribution in the frequency domain (A pseudo-noise, or PN code is a set of time positions defining pseudo-random positioning for each pulse in a sequence of pulses). FIG. 3, when compared to FIG. 2B, shows that the impact of using a PN code is to destroy the comb line structure and spread the energy more uniformly. This structure typically has slight variations that are characteristic of the specific code used.

Coding also provides a method of establishing independent communication channels using impulse radio. Codes can be designed to have low cross correlation such that a pulse train using one code will seldom collide on more than one or two pulse positions with a pulses train using another code during any one data bit time. Since a data bit may comprise hundreds of pulses, this represents a substantial attenuation of the unwanted channel.

### Modulation

Any aspect of the waveform can be modulated to convey information. Amplitude modulation, phase modulation, frequency modulation, time shift modulation and M-ary versions of these have been proposed. Both analog and digital forms have been implemented. Of these, digital time shift modulation has been demonstrated to have various advantages and can be easily implemented using a correlation receiver architecture.

Digital time shift modulation can be implemented by shifting the coded time position by an additional amount (that is, in addition to code dither) in response to the information signal. This amount is typically very small relative to the code shift. In a 10 Mpps system with a center frequency of 2 GHz., for example, the code may command pulse position variations over a range of 100 ns; whereas, the information modulation may only deviate the pulse position by 150 ps.

Thus, in a pulse train of n pulses, each pulse is delayed a different amount from its respective time base clock position by an individual code delay amount plus a modulation amount, where n is the number of pulses associated with a given data symbol digital bit.

Modulation further smooths the spectrum, minimizing structure in the resulting spectrum.

### Reception and Demodulation

Clearly, if there were a large number of impulse radio users within a confined area, there might be mutual interference. Further, while coding minimizes that interference, as the number of users rises, the probability of an individual pulse from one user's sequence being received simultaneously with a pulse from another user's sequence increases. Impulse radios are able to perform in these environments, in part, because they do not depend on receiving every pulse. The impulse radio receiver performs a correlating, synchronous receiving function (at the RF level) that uses a statistical sampling and combining of many pulses to recover the transmitted information. Impulse radio receivers typically integrate from 1 to 1000 or more pulses to yield the demodulated output. The optimal number of pulses over which the receiver integrates is dependent on a number of variables, including pulse rate, bit rate, interference levels, and range.

### Interference Resistance

Besides channelization and energy smoothing, coding also makes impulse radios highly resistant to interference from all radio communications systems, including other impulse radio transmitters. This is critical as any other signals within the band occupied by an impulse signal potentially interfere with the impulse radio. Since there are currently no unallocated bands available for impulse systems, they must share spectrum with other conventional radio systems without being adversely affected. The code helps impulse systems discriminate between the intended impulse transmission and interfering transmissions from others.

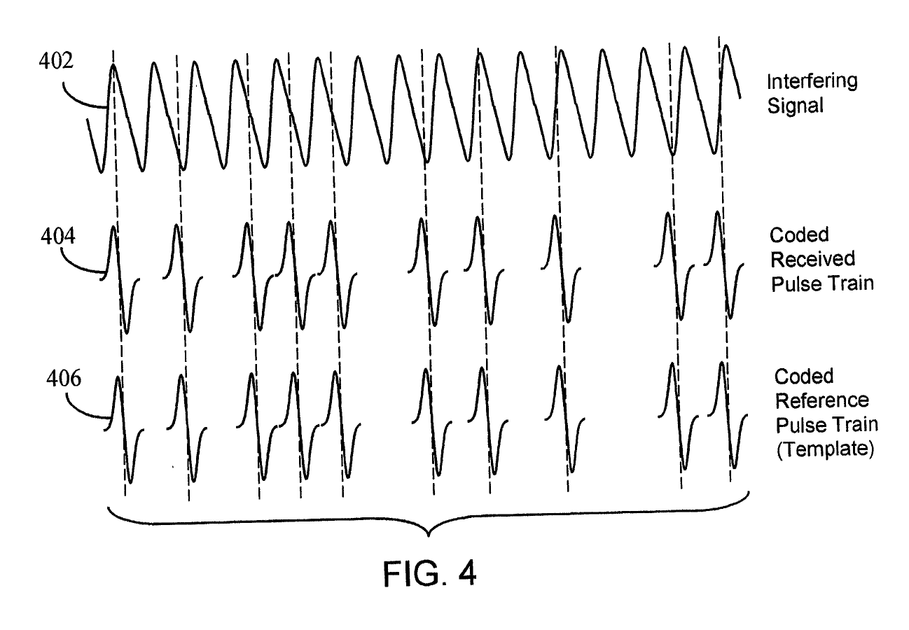

FIG. 4 illustrates the result of a narrow band sinusoidal interference signal 402 overlaying an impulse radio signal 404. At the impulse radio receiver, the input to the cross correlation would include the narrow band signal 402, as well as the received ultrawide-band impulse radio signal 404. The input is sampled by the cross correlator with a code dithered template signal 406. Without coding, the cross correlation would sample the interfering signal 402 with such regularity that the interfering signals could cause significant interference to the impulse radio receiver. However, when the transmitted impulse signal is encoded with the code dither (and the impulse radio receiver template signal 406 is synchronized with that identical code dither) the correlation samples the interfering signals non-uniformly. The samples from the interfering signal add incoherently, increasing roughly according to square root of the number of samples integrated; whereas, the impulse radio samples add coherently, increasing directly according to the number of samples integrated. Thus, integrating over many pulses overcomes the impact of interference.

### Processing Gain

Impulse radio is resistant to interference because of its large processing gain. For typical spread spectrum systems, the definition of processing gain, which quantifies the decrease in channel interference when wide-band communications are used, is the ratio of the bandwidth of the channel to the bit rate of the information signal. For example, a direct sequence spread spectrum system with a 10 KHz information bandwidth and a 10 MHz channel bandwidth yields a processing gain of 1000 or 30 dB. However, far greater processing gains are achieved by impulse radio systems, where the same 10 KHz information bandwidth is spread across a much greater 2 GHz channel bandwidth, resulting in a theoretical processing gain of 200,000 or 53 dB.

### Capacity

It has been shown theoretically, using signal to noise arguments, that thousands of simultaneous voice channels are available to an impulse radio system as a result of the exceptional processing gain, which is due to the exceptionally wide spreading bandwidth.

For a simplistic user distribution, with N interfering users of equal power equidistant from the receiver, the total interference signal to noise ratio as a result of these other users can be described by the following equation:

$${V}_{tot}^{2} = \frac{N {σ}^{2}}{\sqrt{Z}}$$

Where V²ₜₒₜ is the total interference signal to noise ratio variance, at the receiver;

N is the number of interfering users;

σ² is the signal to noise ratio variance resulting from one of the interfering signals with a single pulse cross correlation; and

Z is the number of pulses over which the receiver integrates to recover the modulation.

This relationship suggests that link quality degrades gradually as the number of simultaneous users increases. It also shows the advantage of integration gain. The number of users that can be supported at the same interference level increases by the square root of the number of pulses integrated.

### Multipath and Propagation

One of the striking advantages of impulse radio is its resistance to multipath fading effects. Conventional narrow band systems are subject to multipath through the Rayleigh fading process, where the signals from many delayed reflections combine at the receiver antenna according to their seemingly random relative phases This results in possible summation or possible cancellation, depending on the specific propagation to a given location. This situation occurs where the direct path signal is weak relative to the multipath signals, which represents a major portion of the potential coverage of a radio system. In mobile systems, this results in wild signal strength fluctuations as a function of distance traveled, where the changing mix of multipath signals results in signal strength fluctuations for every few feet of travel.

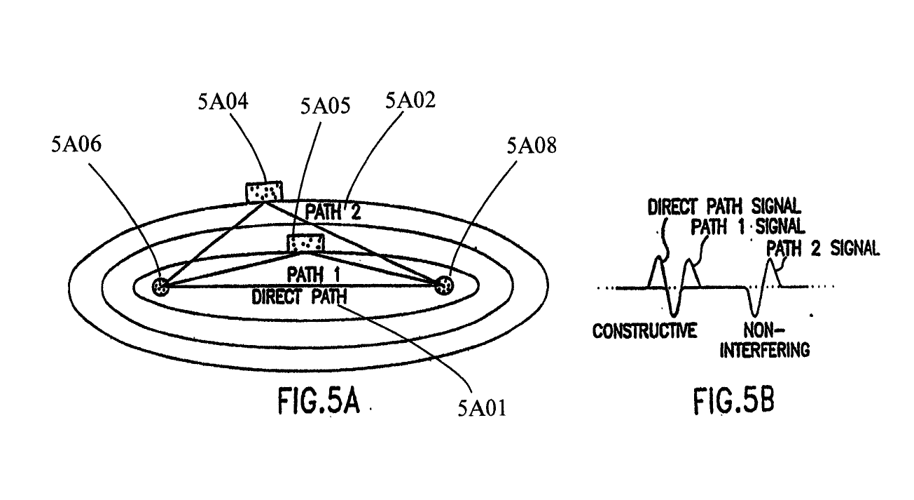

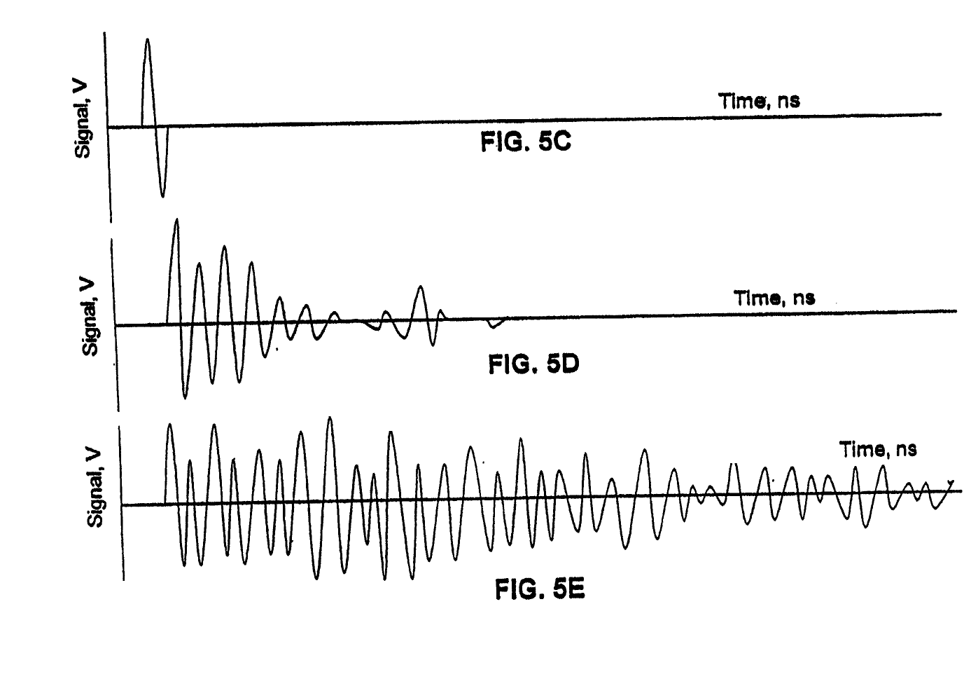

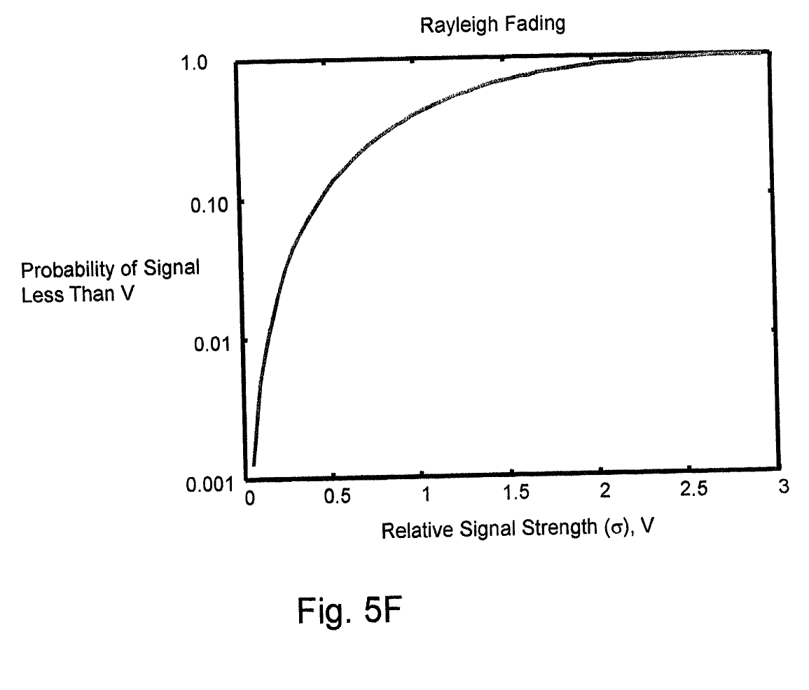

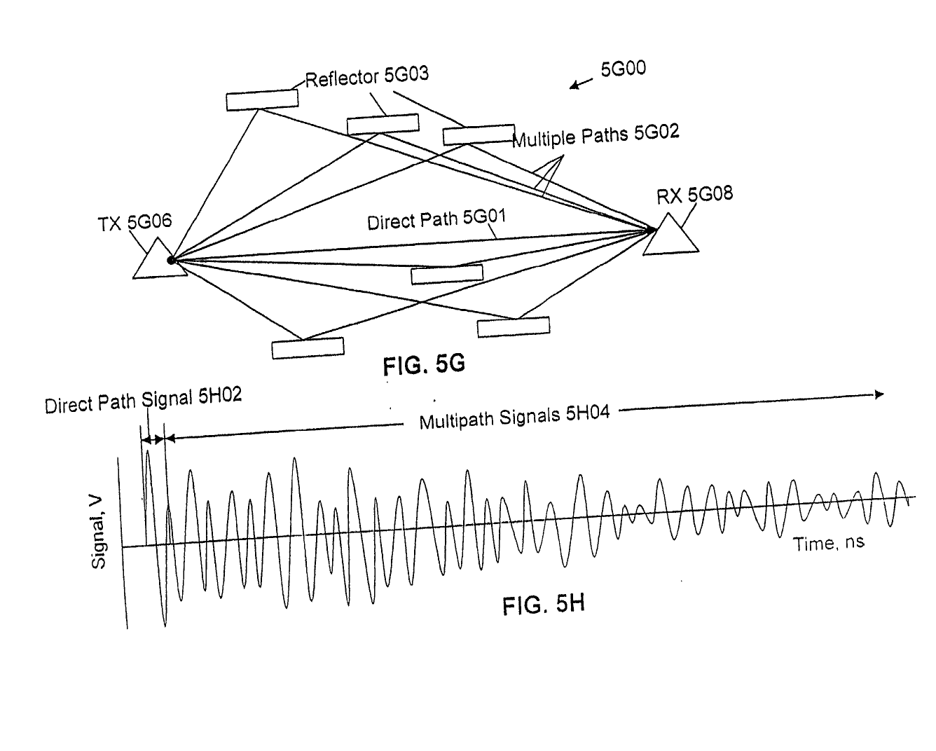

Impulse radios, however, can be substantially resistant to these effects. Impulses arriving from delayed multipath reflections typically arrive outside of the correlation time and thus can be ignored. This process is described in detail with reference to FIGS. 5A and 5B. In FIG. 5A, three propagation paths are shown. The direct path representing the straight-line distance between the transmitter and receiver is the shortest. Path 1 represents a grazing multipath reflection, which is very close to the direct path. Path 2 represents a distant multipath reflection. Also shown are elliptical (or, in space, ellipsoidal) traces that represent other possible locations for reflections with the same time delay.

FIG. 5B represents a time domain plot of the received waveform from this multipath propagation configuration. This figure comprises three doublet pulses as shown in FIG. 1A. The direct path signal is the reference signal and represents the shortest propagation time. The path 1 signal is delayed slightly and actually overlaps and enhances the signal strength at this delay value. Note that the reflected waves are reversed in polarity. The path 2 signal is delayed sufficiently that the waveform is completely separated from the direct path signal. If the correlator template signal is positioned at the direct path signal, the path 2 signal will produce no response. It can be seen that only the multipath signals resulting from very close reflectors have any effect on the reception of the direct path signal. The multipath signals delayed less than one quarter wave (one quarter wave is about 1.5 inches, or 3.5 cm at 2 GHz center frequency) are the only multipath signals that can attenuate the direct path signal. This region is equivalent to the first Fresnel zone familiar to narrow band systems designers. Impulse radio, however, has no further nulls in the higher Fresnel zones. The ability to avoid the highly variable attenuation from multipath gives impulse radio significant performance advantages.

FIG. 5A illustrates a typical multipath situation, such as in a building, where there are many reflectors 5A04, 5A05 and multiple propagation paths 5A02, 5A01. In this figure, a transmitter TX 5A06 transmits a signal that propagates along the multiple propagation paths 5A02, 5A04 to receiver RX 5A08, where the multiple reflected signals are combined at the antenna.

FIG. 5B illustrates a resulting typical received composite pulse waveform resulting from the multiple reflections and multiple propagation paths 5A01, 5A02. In this figure, the direct path signal 5A01 is shown as the first pulse signal received. The multiple reflected signals (“multipath signals”, or “multipath”) comprise the remaining response as illustrated.

FIGS. 5C, 5D, and 5E represent the received signal from a TM-UWB transmitter in three different multipath environments. These figures are not actual signal plots, but are hand drawn plots approximating typical signal plots. FIG. 5C illustrates the received signal in a very low multipath environment. This may occur in a building where the receiver antenna is in the middle of a room and is one meter from the transmitter. This may also represent signals received from some distance, such as 100 meters, in an open field where there are no objects to produce reflections. In this situation, the predominant pulse is the first received pulse and the multipath reflections are too weak to be significant. FIG. 5D illustrates an intermediate multipath environment. This approximates the response from one room to the next in a building. The amplitude of the direct path signal is less than in FIG. 5C and several reflected signals are of significant amplitude. FIG. 5E approximates the response in a severe multipath environment such as: propagation through many rooms; from corner to corner in a building; within a metal cargo hold of a ship; within a metal truck trailer; or within an intermodal shipping container. In this scenario, the main path signal is weaker than in FIG. 5D. In this situation, the direct path signal power is small relative to the total signal power from the reflections.

An impulse radio receiver can receive the signal and demodulate the information using either the direct path signal or any multipath signal peak having sufficient signal to noise ratio. Thus, the impulse radio receiver can select the strongest response from among the many arriving signals. In order for the signals to cancel and produce a null at a given location, dozens of reflections would have to be cancelled simultaneously and precisely while blocking the direct path—a highly unlikely scenario. This time separation of multipath signals together with time resolution and selection by the receiver permit a type of time diversity that virtually eliminates cancellation of the signal. In a multiple correlator rake receiver, performance is further improved by collecting the signal power from multiple signal peaks for additional signal to noise performance.

Where the system of FIG. 5A is a narrow band system and the delays are small relative to the data bit time, the received signal is a sum of a large number of sine waves of random amplitude and phase. In the idealized limit, the resulting envelope amplitude has been shown to follow a Rayleigh probability distribution as follows:

$$p ( r ) = \frac{1}{{σ}^{2}} exp ( \frac{- {r}^{2}}{2 {σ}^{2}} )$$

where r is the envelope amplitude of the combined multipath signals, and 2σ² is the RMS power of the combined mulitpath signals.

This distribution is shown in FIG. 5F. It can be seen in FIG. 5F that 10% of the time, the signal is more than 16 dB attenuated. This suggests that 16 dB fade margin is needed to provide 90% link availability. Values of fade margin from 10 to 40 dB have been suggested for various narrow band systems, depending on the required reliability. This characteristic has been the subject of much research and can be partially improved by such techniques as antenna and frequency diversity, but these techniques result in additional complexity and cost.

In a high multipath environment such as inside homes, offices, warehouses, automobiles, trailers, shipping containers, or outside in the urban canyon or other situations where the propagation is such that the received signal is primarily scattered energy, impulse radio, according to the present invention, can avoid the Rayleigh fading mechanism that limits performance of narrow band systems. This is illustrated in FIG. 5G and 5H in a transmit and receive system in a high multipath environment 5G00, wherein the transmitter 5G06 transmits to receiver 5G08 with the signals reflecting off reflectors 5G03 which form muitipaths 5G02. The direct path is illustrated as 5G01 with the signal graphically illustrated at 5H02, with the vertical axis being the signal strength in volts and horizontal axis representing time in nanoseconds. Multipath signals are graphically illustrated at 5H04.

### Distance Measurement

Important for positioning, impulse systems can measure distances to extremely fine resolution because of the absence of ambiguous cycles in the waveform. Narrow band systems, on the other hand, are limited to the modulation envelope and cannot easily distinguish precisely which RF cycle is associated with each data bit because the cycle-to-cycle amplitude differences are so small they are masked by link or system noise. Since the impulse radio waveform has no multi-cycle ambiguity, this allows positive determination of the waveform position to less than a wavelength—potentially, down to the noise floor of the system. This time position measurement can be used to measure propagation delay to determine link distance, and once link distance is known, to transfer a time reference to an equivalently high degree of precision. The inventors of the present invention have built systems that have shown the potential for centimeter distance resolution, which is equivalent to about 30 ps of time transfer resolution. See, for example, commonly owned, co-pending applications Ser. No. 09/045,929, filed Mar. 23, 1998, titled “Ultrawide-Band Position Determination System and Method”, and Ser. No. 09/083,993, filed May 26, 1998, titled “System and Method for Distance Measurement by Inphase and Quadrature Signals in a Radio System,” both of which are incorporated herein by reference.

In addition to the methods articulated above, impulse radio technology along with Time Division Multiple Access algorithms and Time Domain packet radios can achieve geo-positioning capabilities in a radio network. This geo-positioning method allows ranging to occur within a network of radios without the necessity of a full duplex exchange among every pair of radios.

### Exemplary Transceiver Implementation

### Transmitter

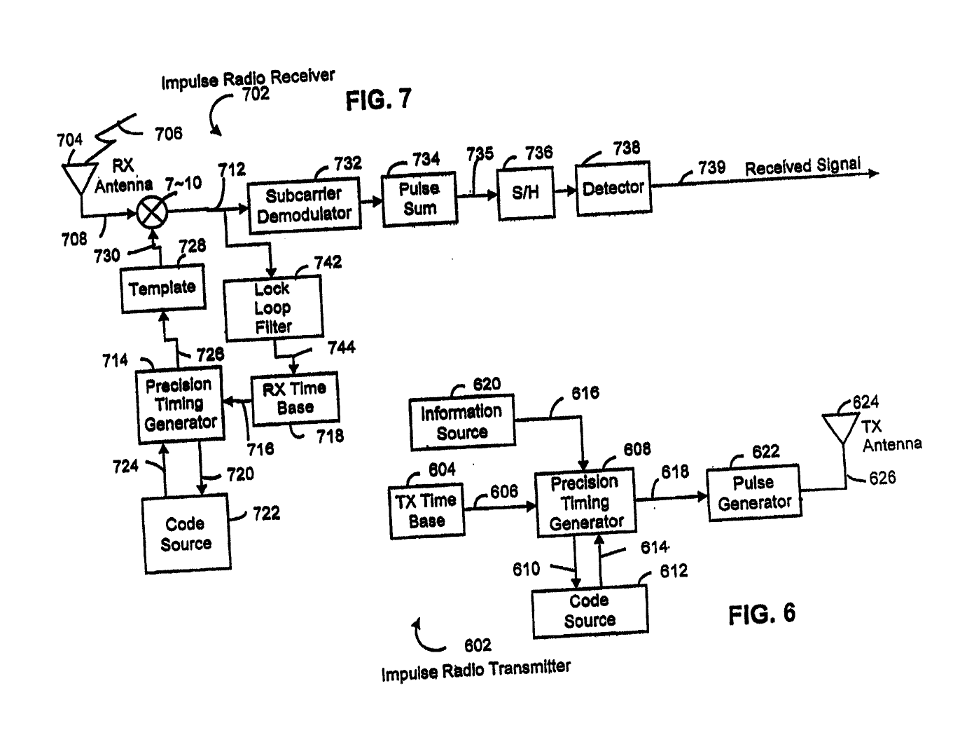

An exemplary embodiment of an impulse radio transmitter 602 of an impulse radio communication system having one subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter, on the order of picoseconds (ps). The voltage control to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614 together with an internally generated subcarrier signal (which is optional) and an information signal 616 to generate a modulated, coded timing signal 618. The code source 612 comprises a storage device such as a random access memory (RAM), read only memory (ROM), or the like, for storing suitable codes and for outputting the PN codes as a code signal 614. Alternatively, maximum length shift registers or other computational means can be used to generate the codes.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger to generate output pulses. The output pulses are sent to a transmit antenna 624 via a transmission line 626 coupled thereto. The output pulses are converted into propagating electromagnetic pulses by the transmit antenna 624. In the present embodiment, the electromagnetic pulses are called the emitted signal, and propagate to an impulse radio receiver 702, such as shown in FIG. 7, through a propagation medium, such as air, in a radio frequency embodiment. In a preferred embodiment, the emitted signal is wide-band or ultrawide-band, approaching a monocycle pulse as in FIG. 1A. However, the emitted signal can be spectrally modified by filtering of the pulses. This bandpass filtering will cause each monocycle pulse to have more zero crossings (more cycles) in the time domain. In this case, the impulse radio receiver can use a similar waveform as the template signal in the cross correlator for efficient conversion.

### Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710 via a receiver transmission line, coupled to the receive antenna 704, and producing a baseband output 712.

The receiver 702 also includes a precision timing generator 714, which receives a periodic timing signal 716 from a receiver time base 718. This time base 718 is adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 ideally comprises a multiplier followed by a short term integrator to sum the multiplier product over the pulse interval.

The output of the correlator 710 is coupled to a subcarrier demodulator 732, which demodulates the subcarrier information signal from the subcarrier. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to determine an output signal 739 representing the digital state of the output voltage of sample and hold 736.

The baseband signal 712 is also input to a lowpass filter 742 (also referred to as lock loop filter 742). A control loop comprising the lowpass filter 742, time base 718, precision timing generator 714, template generator 728, and correlator 710 is used to generate an error signal 744. The error signal 744 provides adjustments to the adjustable time base 718 to time position the periodic timing signal 726 in relation to the position of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

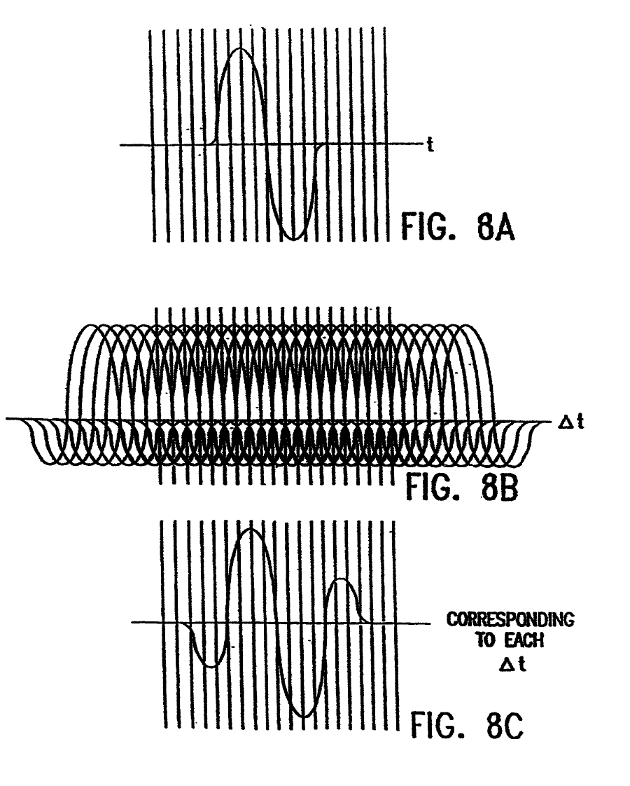

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the correlator (multiplier and short time integrator) for each of the time offsets of FIG. 8B. Thus, this graph does not show a waveform that is a function of time, but rather a function of time-offset. For any given pulse received, there is only one corresponding point that is applicable on this graph. This is the point corresponding to the time offset of the template signal used to receive that pulse. Further examples and details of precision timing can be found described in U.S. Pat. No. 5,677,927, and commonly owned co-pending application Ser. No. 09/146,524, filed Sep. 3, 1998, titled “Precision Timing Generator System and Method” both of which are incorporated herein by reference.

### Recent Advances in Impulse Radio Communication

### Modulation Techniques

To improve the placement and modulation of pulses and to find new and improved ways that those pulses transmit information, various modulation techniques have been developed. The modulation techniques articulated above as well as the recent modulation techniques invented and summarized below are incorporated herein by reference.

### FLIP Modulation

An impulse radio communications system can employ FLIP modulation techniques to transmit and receive flip modulated impulse radio signals. Further, it can transmit and receive flip with shift modulated (also referred to as quadrature flip time modulated (QFTM)) impulse radio signals. Thus, FLIP modulation techniques can be used to create two, four, or more different data states.

Flip modulators include an impulse radio receiver with a time base, a precision timing generator, a template generator, a delay, first and second correlators, a data detector and a time base adjustor. The time base produces a periodic timing signal that is used by the precision timing generator to produce a timing trigger signal. The template generator uses the timing trigger signal to produce a template signal. A delay receives the template signal and outputs a delayed template signal. When an impulse radio signal is received, the first correlator correlates the received impulse radio signal with the template signal to produce a first correlator output signal, and the second correlator correlates the received impulse radio signal with the delayed template signal to produce a second correlator output signal. The data detector produces a data signal based on at least the first correlator output signal. The time base adjustor produces a time base adjustment signal based on at least the second correlator output signal. The time base adjustment signal is used to synchronize the time base with the received impulse radio signal.

For greater elaboration of FLIP modulation techniques, the reader is directed to the patent application entitled, “Apparatus, System and Method for FLIP Modulation in an Impulse Radio Communication System”, Ser. No. 09/537,692, filed Mar. 29, 2000 and assigned to the assignee of the present invention. This patent application is incorporated herein by reference.

### Vector Modulation

Vector Modulation is a modulation technique which includes the steps of generating and transmitting a series of time-modulated pulses, each pulse delayed by one of four pre-determined time delay periods and representative of at least two data bits of information, and receiving and demodulating the series of time-modulated pulses to estimate the data bits associated with each pulse. The apparatus includes an impulse radio transmitter and an impulse radio receiver.

The transmitter transmits the series of time-modulated pulses and includes a transmitter time base, a time delay modulator, a code time modulator, an output stage, and a transmitting antenna. The receiver receives and demodulates the series of time-modulated pulses using a receiver time base and two correlators, one correlator designed to operate after a pre-determined delay with respect to the other correlator. Each correlator includes an integrator and a comparator, and may also include an averaging circuit that calculates an average output for each correlator, as well as a track and hold circuit for holding the output of the integrators. The receiver further includes an adjustable time delay circuit that may be used to adjust the pre-determined delay between the correlators in order to improve detection of the series of time-modulated pulses.

For greater elaboration of Vector modulation techniques, the reader is directed to the patent application entitled, “Vector Modulation System and Method for Wideband Impulse Radio Communications”, Ser. No. 09/169,765, filed Dec. 9, 1999 and assigned to the assignee of the present invention. This patent application is incorporated herein by reference.

### Receivers

Because of the unique nature of impulse radio receivers several modifications have been recently made to enhance system capabilities.

### Multiple Correlator Receivers

Multiple correlator receivers utilize multiple correlators that precisely measure the impulse response of a channel and wherein measurements can extend to the maximum communications range of a system, thus, not only capturing ultra-wideband propagation waveforms, but also information on data symbol statistics. Further, multiple correlators enable rake acquisition of pulses and thus faster acquisition, tracking implementations to maintain lock and enable various modulation schemes. Once a tracking correlator is synchronized and locked to an incoming signal, the scanning correlator can sample the received waveform at precise time delays relative to the tracking point. By successively increasing the time delay while sampling the waveform, a complete, time-calibrated picture of the waveform can be collected.

For greater elaboration of utilizing multiple correlator techniques, the reader is directed to the patent application entitled, “System and Method of using Multiple Correlator Receivers in an Impulse Radio System”, Ser. No. 09/537,264, filed Mar. 29, 2000 and assigned to the assignee of the present invention. This patent application is incorporated herein by reference.

### Fast Locking Mechanisms

Methods to improve the speed at which a receiver can acquire and lock onto an incoming impulse radio signal have been developed. In one approach, a receiver comprises an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in detail in U.S. Pat. No. 5,832,035 to Fullerton, incorporated herein by reference.

In another approach, a receiver obtains a template pulse train and a received impulse radio signal. The receiver compares the template pulse train and the received impulse radio signal to obtain a comparison result. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, the reader is directed to the patent application entitled, “Method and System for Fast Acquisition of Ultra Wideband Signals”, Ser. No. 09/538,292, filed Mar. 29, 2000 and assigned to the assignee of the present invention. This patent application is incorporated herein by reference.

### Baseband Signal Converters

A receiver has been developed which includes a baseband signal converter device and combines multiple converter circuits and an RF amplifier in a single integrated circuit package. Each converter circuit includes an integrator circuit that integrates a portion of each RF pulse during a sampling period triggered by a timing pulse generator. The integrator capacitor is isolated by a pair of Schottky diodes connected to a pair of load resistors. A current equalizer circuit equalizes the current flowing through the load resistors when the integrator is not sampling. Current steering logic transfers load current between the diodes and a constant bias circuit depending on whether a sampling pulse is present.

For greater elaboration of utilizing baseband signal converters, the reader is directed to the patent application entitled, “Baseband Signal Converter for a Wideband Impulse Radio Receiver”, Ser. No. 09/356,384, filed Jul. 16, 1999 and assigned to the assignee of the present invention. This patent application is incorporated herein by reference.

### Power Control and Interference

### Power Control

Power control improvements have been invented with respect to impulse radios. The power control systems comprise a first transceiver that transmits an impulse radio signal to a second transceiver. A power control update is calculated according to a performance measurement of the signal received at the second transceiver. The transmitter power of either transceiver, depending on the particular embodiment, is adjusted according to the power control update. Various performance measurements are employed according to the current invention to calculate a power control update, including bit error rate, signal-to-noise ratio, and received signal strength, used alone or in combination. Interference is thereby reduced, which is particularly important where multiple impulse radios are operating in close proximity and their transmissions interfere with one another. Reducing the transmitter power of each radio to a level that produces satisfactory reception increases the total number of radios that can operate in an area without saturation. Reducing transmitter power also increases transceiver efficiency.

For greater elaboration of utilizing baseband signal converters, the reader is directed to the patent application entitled, “System and Method for Impulse Radio Power Control”, Ser. No. 09/332,501, filed Jun. 14, 1999 and assigned to the assignee of the present invention. This patent application is incorporated herein by reference.

### Mitigating Effects of Interference

To assist in mitigating interference to impulse radio systems a methodology has been invented. The method comprises the steps of: (a) conveying the message in packets; (b) repeating conveyance of selected packets to make up a repeat package; and (c) conveying the repeat package a plurality of times at a repeat period greater than twice the occurrence period of the interference. The communication may convey a message from a proximate transmitter to a distal receiver, and receive a message by a proximate receiver from a distal transmitter. In such a system, the method comprises the steps of: (a) providing interference indications by the distal receiver to the proximate transmitter; (b) using the interference indications to determine predicted noise periods; and (c) operating the proximate transmitter to convey the message according to at least one of the following: (1) avoiding conveying the message during noise periods; (2) conveying the message at a higher power during noise periods; (3) increasing error detection coding in the message during noise periods; (4) re-transmitting the message following noise periods; (5) avoiding conveying the message when interference is greater than a first strength; (6) conveying the message at a higher power when the interference is greater than a second strength; (7) increasing error detection coding in the message when the interference is greater than a third strength; and (8) re-transmitting a portion of the message after interference has subsided to less than a predetermined strength.

For greater elaboration of mitigating interference to impulse radio systems, the reader is directed to the patent application entitled, “Method for Mitigating Effects of Interference in Impulse Radio Communication”, Ser. No. 09/587,033, filed Jun. 02, 1999 and assigned to the assignee of the present invention. This patent application is incorporated herein by reference.

### Moderating Interference while Controlling Equipment

Yet another improvement to impulse radio includes moderating interference with impulse radio wireless control of an appliance; the control is affected by a controller remote from the appliance transmitting impulse radio digital control signals to the appliance. The control signals have a transmission power and a data rate. The method comprises the steps of: (a) in no particular order: (1) establishing a maximum acceptable noise value for a parameter relating to interfering signals; (2) establishing a frequency range for measuring the interfering signals; (b) measuring the parameter for the interference signals within the frequency range; and (c) when the parameter exceeds the maximum acceptable noise value, effecting an alteration of transmission of the control signals. For greater elaboration of moderating interference while effecting impulse radio wireless control of equipment, the reader is directed to the patent application entitled, “Method and Apparatus for Moderating Interference While Effecting Impulse Radio Wireless Control of Equipment”, Ser. No. 09/586,163, filed Jun. 2, 1999 and assigned to the assignee of the present invention. This patent application is incorporated herein by reference.

### Coding Advances

The improvements made in coding can directly improve the characteristics of impulse radio as used in the present invention. Specialized coding techniques may be employed to establish temporal and/or non-temporal pulse characteristics such that a pulse train will possess desirable properties. Coding methods for specifying temporal and non-temporal pulse characteristics are described in commonly owned, co-pending applications entitled “A Method and Apparatus for Positioning Pulses in Time”, Ser. No. 09/592,249, and “A Method for Specifying Non-Temporal Pulse Characteristics”, Ser. No. 09/592,250, both filed Jun. 12, 2000, and both of which are incorporated herein by reference. Essentially, a temporal or non-temporal pulse characteristic value layout is defined, an approach for mapping a code to the layout is specified, a code is generated using a numerical code generation technique, and the code is mapped to the defined layout per the specified mapping approach.

A temporal or non-temporal pulse characteristic value layout may be fixed or non-fixed and may involve value ranges, discrete values, or a combination of value ranges and discrete values. A value range layout specifies a range of values for a pulse characteristic that is divided into components that are each subdivided into subcomponents, which can be further subdivided, ad infinitum. In contrast, a discrete value layout involves uniformly or non-uniformly distributed discrete pulse characteristic values. A non-fixed layout (also referred to as a delta layout) involves delta values relative to some reference value such as the characteristic value of the preceding pulse. Fixed and non-fixed layouts, and approaches for mapping code element values to them, are described in co-owned, co-pending applications, entitled “Method for Specifying Pulse Characteristics using Codes”, Ser. No. 09/592,290 and “A Method and Apparatus for Mapping Pulses to a Non-Fixed Layout”, Ser. No. 09/591,691, both filed on Jun. 12, 2000 and both of which are incorporated herein by reference.

A fixed or non-fixed characteristic value layout may include one or more non-allowable regions within which a characteristic value of a pulse is not allowed. A method for specifying non-allowable regions to prevent code elements from mapping to non-allowed characteristic values is described in co-owned, co-pending application entitled “A Method for Specifying Non-Allowable Pulse Characteristics”, Ser. No. 09/592,289, filed Jun. 12, 2000 and incorporated herein by reference. A related method that conditionally positions pulses depending on whether or not code elements map to non-allowable regions is described in co-owned, co-pending application, entitled “A Method and Apparatus for Positioning Pulses Using a Layout having Non-Allowable Regions”, Ser. No. 09/592,248 and incorporated herein by reference.

Typically, a code consists of a number of code elements having integer or floating-point values. A code element value may specify a single pulse characteristic (e.g., pulse position in time) or may be subdivided into multiple components, each specifying a different pulse characteristic. For example, a code having seven code elements each subdivided into five components (c0-c4) could specify five different characteristics of seven pulses. A method for subdividing code elements into components is described in commonly owned, co-pending application entitled “Method for Specifying Pulse Characteristics using Codes”, Ser. No. 09/592,290, filed Jun. 12, 2000 previously referenced and again incorporated herein by reference. Essentially, the value of each code element or code element component (if subdivided) maps to a value range or discrete value within the defined characteristic value layout. If a value range layout is used an offset value is typically employed to specify an exact value within the value range mapped to by the code element or code element component.

The signal of a coded pulse train can be generally expressed:

$${s}_{tr}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} , {b}_{j}^{( k )} )$$

where k is the index of a transmitter, j is the index of a pulse within its pulse train, (−1)fⱼ^{(k)}, aⱼ^{(k)}, cⱼ^{(k)}, and bⱼ^{(k)} are the coded polarity, amplitude, widths and waveform of the jth pulse of the kth transmitter, and Tⱼ^{(k)} is the coded time shift of the jth pulse of the kth transmitter. Note: When a given non-temporal characteristic does not vary (i.e., remains constant for all pulses in the pulse train), the corresponding code element component is removed from the above expression and the non-temporal characteristic value becomes a constant in front of the summation sign.

Various numerical code generation methods can be employed to produce codes having certain correlation and spectral properties. Such codes typically fall into one of two categories: designed codes and pseudorandom codes.

A designed code may be generated using a quadratic congruential, hyperbolic congruential, linear congruential, Costas array or other such numerical code generation technique designed to generate codes guaranteed to have certain correlation properties. Each of these alternative code generation techniques has certain characteristics to be considered in relation to the application of the pulse transmission system employing the code. For example, Costas codes have nearly ideal autocorrelation properties but somewhat less than ideal cross-correlation properties, while linear congruential codes have nearly ideal cross-correlation properties but less than ideal autocorrelation properties. In some cases, design tradeoffs may require that a compromise between two or more code generation techniques be made such that a code is generated using a combination of two or more techniques. An example of such a compromise is an extended quadratic congruential code generation approach that uses two ‘independent’ operators, where the first operator is linear and the second operator is quadratic. Accordingly, one, two, or more code generation techniques or combinations of such techniques can be employed to generate a code without departing from the scope of the invention.

A pseudorandom code may be generated using a computer's random number generator, binary shift-register(s) mapped to binary words, a chaotic code generation scheme, or another well-known technique. Such ‘random-like’ codes are attractive for certain applications since they tend to spread spectral energy over multiple frequencies while having ‘good enough’ correlation properties, whereas designed codes may have superior correlation properties but have spectral properties that may not be as suitable for a given application.

Computer random number generator functions commonly employ the linear congruential generation (LCG) method or the Additive Lagged-Fibonacci Generator (ALFG) method. Alternative methods include inversive congruential generators, explicit-inversive congruential generators, multiple recursive generators, combined LCGs, chaotic code generators, and Optimal Golomb Ruler (OGR) code generators. Any of these or other similar methods can be used to generate a pseudorandom code without departing from the scope of the invention, as will be apparent to those skilled in the relevant art.

Detailed descriptions of code generation and mapping techniques are included in a co-owned patent application entitled “A Method and Apparatus for Positioning Pulses in Time”, Attorney Docket #: 28549-165554, which is hereby incorporated by reference.

It may be necessary to apply predefined criteria to determine whether a generated code, code family, or a subset of a code is acceptable for use with a given UWB application. Criteria to consider may include correlation properties, spectral properties, code length, non-allowable regions, number of code family members, or other pulse characteristics. A method for applying predefined criteria to codes is described in co-owned, co-pending application, entitled “A Method and Apparatus for Specifying Pulse Characteristics using a Code that Satisfies Predefined Criteria”, Ser. No. 09/592,288, filed Jun. 12, 2000 and is incorporated herein by reference.

In some applications, it may be desirable to employ a combination of two or more codes. Codes may be combined sequentially, nested, or sequentially nested, and code combinations may be repeated. Sequential code combinations typically involve transitioning from one code to the next after the occurrence of some event. For example, a code with properties beneficial to signal acquisition might be employed until a signal is acquired, at which time a different code with more ideal channelization properties might be used. Sequential code combinations may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in desirable spectral properties. A method for applying code combinations is described in co-owned, co-pending application, entitled “A Method and Apparatus for Applying Codes Having Pre-Defined Properties”, Ser. No. 09/591,690, filed Jun. 12, 2000 which is incorporated herein by reference.

### PREFERRED EMBODIMENTS OF THE PRESENT INVENTION

The invention provides a hand-held scanner 902 for scanning information and then wirelessly transferring said information to a remote location. This information can be text data such as in the case of note taking, i.e., acquiring textual information from written and printed sources. Or it can be bar code scanning information such as in the case of inventory control for a grocery store or any other circumstance where information can be bar-coded, scanned and recorded in a remote location. The description herein will be predominantly related to text scanning as this is the most complicated of the embodiments; however, it is understood that the present invention and the novel use of impulse radio wireless transfer techniques can also be used in association with any scenario where information is obtained by scanning methods and then wirelessly transferred to a remote location.

The scanner is capable of reading and storing selected information, for example, some or all of the characters from a given line of text. The scanner has a scanner head at its front end having an area of view sized for compatibility with printed characters having conventional point sizes. An embodiment of the scanner of the invention may be advantageously provided with a lens of variable magnification to accommodate a wide range of point sizes. The scanner 902 is stroked along adjacent a line of text, so that each character in turn is partially in the area of view. In this way the area of view accomplishes a succession of substantially vertical slices of each character. In accordance with another embodiment of the present invention, an optical image splitter is provided in the scanner to rotate the area of view so that additionally and simultaneously a horizontal slice may be taken from the character and recorded. Each slice or frame is stored in a series of digital data records. The digital records are then transferred via impulse radio wireless means (described above and in the patents and patent applications incorporated herein by reference) from the scanner to the host computer. The impulse radio transceiver and impulse radio antenna 916 can be located within the hand-held scanner 902. By using an impulse radio transceiver and impulse radio wireless transfer means, one can dramatically improve the data transfer ability and extend the battery life of a handheld scanner. The reasons for the dramatic improvement are described above and in the patents and patent applications incorporated herein by reference.

A computer equipped with OCR (Optical Character Recognition) software can transform the succession of digital records into an ASCII text file. Or the computer may contain a database of information from which an inventory control system can be placed and provided the inventory control database information from the handheld scanner which has transferred information to the computer via impulse radio wireless means.

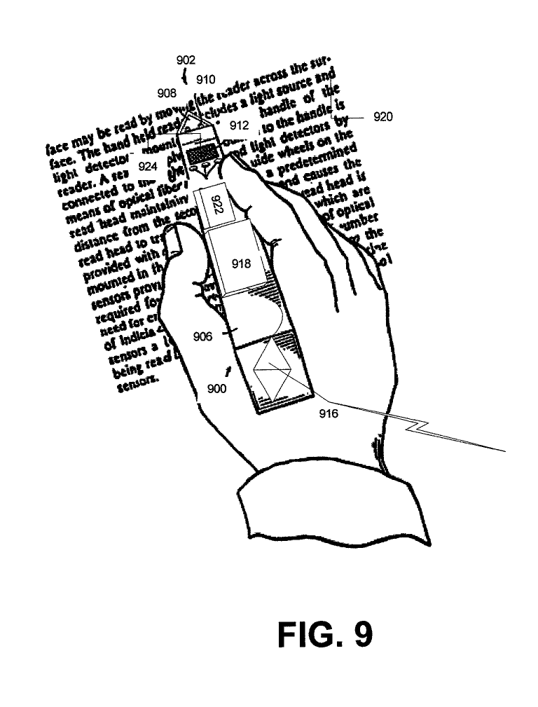

Referring now to FIG. 9, a scanner 902 of the present invention is illustrated. The scanner may be used in its character-by-character mode, in which it scans a line of characters on a surface 920 (e.g., paper) while the scanner 902 is held like a pen underlining that line. The housing 906 of the scanner is elongate in shape in order to allow the scanner to be held like a pen. Moreover, because the scanner is sized and shaped like a pen, it can be used as a pen or a pointing device for pen computing when connected to an appropriate host computer. Although, the preferred embodiment is pen-shaped it is understood that the shape of the hand-held scanner can be one that is most convenient to the scanning job required with the primary requirement being the ability to contain an impulse radio transmitter and antenna.

The scanner housing 906 has an opening 908 or window through which a light-detector 912 receives the light reflected off of the surface 920. A light source, for example a pair of lights 910, may be used to direct light onto that portion of the surface 920 which is being read by the scanner. Ambient light or a single light source may in many cases be sufficient. The lights 910 may be a pair of light emitting diodes. The area of view illuminated by the lights 910 is visible to the user above the front tip of the scanner 902. The entire line being scanned is visible during scanning as shown in FIG. 9.

The character-by-character mode of the scanner may be provided with a zoom capability to allow the scanner to read all point sizes normally encountered on a printed page. The zoom capability may be provided either by an internal multi-element lens configuration adjusted electronically through a motor to read wide or long or by a zoom lens attachment to be affixed to the tip of the scanner.

A microphone 924 may be incorporated into the scanner 902. The microphone 924 records comments spoken by the user of the scanner. The analog recording of the spoken comments pass through an analog to digital converter (not shown), through an impulse radio interface 922 and into the impulse radio transceiver or transmitter 918 for transmission via impulse radio antenna 916 for wireless impulse radio transmission from the scanner to a host computer or a recorder. The computer may be provided with a speech recognition processor and/or a digital recorder.

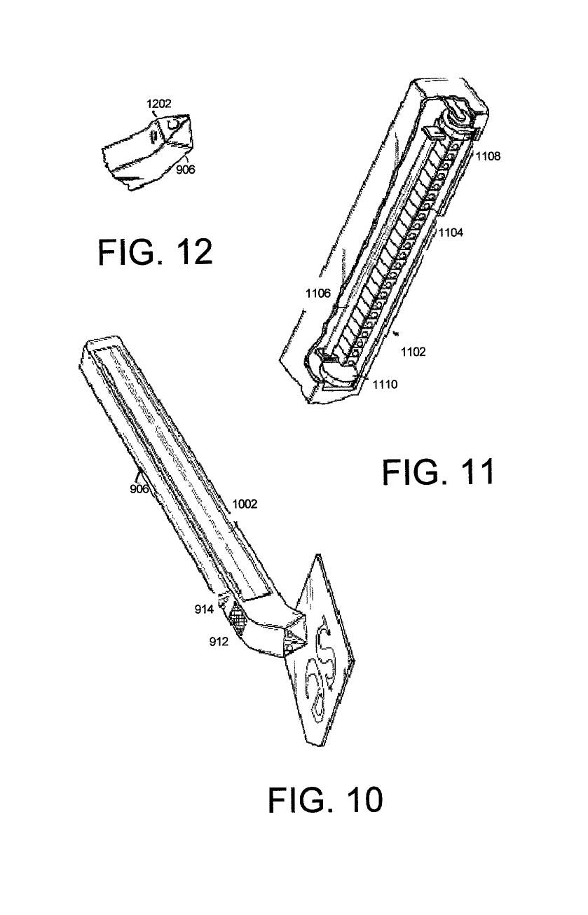

The microphone 924 allows the user of the scanner to annotate what is being scanned. For instance, the user may be researching in a library or may be scanning a given inventory area. When the researcher finds an important passage in a book, he may wish to scan and save that passage for later reference. A series of control buttons 914 (see FIG. 10) are provided on top of the scanner 902. One of these buttons 914 is operable to switch the scanner 902 from character scanning mode to microphone mode. By using the microphone, the researcher may record the source of the scanned passage, i.e., the title and author of the book and the page the passage was located, as well as the researcher's thoughts regarding the passage. If a speech-recognition processor is used, the researcher may later view his comments on a computer terminal along with the scanned passage. If a speech-recognition processor is not used, and instead the spoken comments are simply recorded, the researcher may listen to the comments later.

Referring now to FIGS. 10 and 11, an embodiment of the scanner also includes a line-by-line scanner 1102, such as a four-inch-wide scanner. This line-by-line scanner is located along the length of the elongate housing 906 (see FIG. 9). A flap 1002 is mounted along the length of the housing 906 so that when the flap is opened, the side of the scanner may be placed adjacent the surface 920 at the top of a passage to be scanned. The scanner is then drawn over the page (or in the case of a bar code, over the bar code area affixed to an item). This is repeated as many times as necessary to cover the whole page (or to the completion of the items affixed with bar codes desired to be scanned). Software in the host computer may be provided to piece together images obtained from multiple sweeps across a page to produce a readable ASCII file of the text on the page. Columns less than four inches in width can be scanned in a single sweep down the page. The line-by-line scanner obliterates the lines from view as they are scanned, but since a large body of text covering a page or column is being scanned there is little need for the user to follow along as with the character-by-character scanner. The line-by-line scanner is more efficient for scanning longer passages than the character-by-character scanner. Also, the line-by-line scanner may be used in scanning non-textual continuous-tone images. When a continuous-tone image is scanned, the bit map of information detected by the scanner is stored for later retrieval and display. When characters are scanned, a character-recognition processor is preferably used in order to convert the character information into ASCII or similar format. The flap 1002 may be attached to a switch in order to indicate that the line-by-line scanner is in use and to turn off the character-by-character scanner as well as to signal to the host computer which mode is in use.

As shown in FIG. 11, the line-by-line scanner 1102 includes a linear array of photodiodes 1104 for detecting the intensity of light reflected from the surface. The photodiodes 1104 do not require optical lenses for directing the light. Instead of photodiodes, alternative photodetectors such as CCD's with associated optics may be used. A light source 1106 produces the light for reflection off the surface. The light source 1106 may be fluorescent. Encoder wheels 1110 may be spring mounted behind the sliding door 1002 so that they extend out from the scanner when the door is opened to reveal the line-by-line scanner. The encoder wheels 1110 provide location signals for coordinating with the image information so that the shapes of the characters being scanned are not adversely influenced by the speed with which the scanner 1102 is moved across the surface. A data frame is captured from the photodiodes 1104 and stored in response to movement of the scanner 1102 a predetermined distance, such as every 1/300 of an inch, as detected by the encoder wheels 1110.

An encoder wheel may also be mounted beneath the front tip of the scanner for use with the character-by-character scanner. In accordance with an embodiment of the present invention, the encoder wheel is replaced by a ball 1202 rotatably mounted in the scanner housing 906 as shown in FIG. 12. The ball 1202 can be used to track the movement of the scanner across the surface, in the same way that a ball in a computer mouse tracks the movement of the mouse. Unlike a wheel, the ball 1202 is able to track movement in two dimensions. By using an encoding ball 1202 instead of a wheel, the scanner may be used as a mouse for a personal computer, when not functioning as a scanner. One of the buttons 914 (see FIG. 10) may be used to switch from scanning mode to mouse mode. Instead of using the buttons 914 on the scanner itself, the mode of the scanner may be switched by interacting with software designed for that purpose on the host computer. In mouse mode, movement along orthogonal coordinates will both be detected by an X movement sensor and a Y movement sensor. Only movement along one coordinate is detected in the scanning mode to track movement along a line of text. When rotational movement of the encoding ball 1202 stops, when it is lifted up at the end of a line for instance, the scanner stops sending the scanning data. The computer may respond, if so programmed, to a stop in data by inserting a single soft carriage return. Also, the position of the scanner relative to the computer is constantly monitored by impulse radio means described above and in the patents and patent applications incorporated herein by reference. Thus, the data rate is adjusted or the data transmission is stopped depending on the distance from the scanner to the computer. A notification means such as a light or audible beep can be used to alert a user that the scanner is moving out of range of the remote computer.

The line-by-line scanner 1102 may be located on the same side of the scanner housing as the encoding ball so that the encoding ball can be used to provide information regarding the movement of the scanner in both its character-by-character and its line-by-line modes. As such, the encoding wheels 1110 may be eliminated. Alternatively, an internal clock may be set for a standard rate of scanning. Such an internal clock may be used in either of the line-by-line or character-by-character modes, in lieu of an encoding wheel or ball. By using the internal clock, the scanner reads x samples per second regardless of how quickly the scanner is moved across the surface 920. The character-recognition processor can recognize the characters being scanned as long as the scanner is moved at a speed within a range around the speed at which the scanner is set. Such an internal timing device may be arranged in parallel with a wheel-encoder-based system.

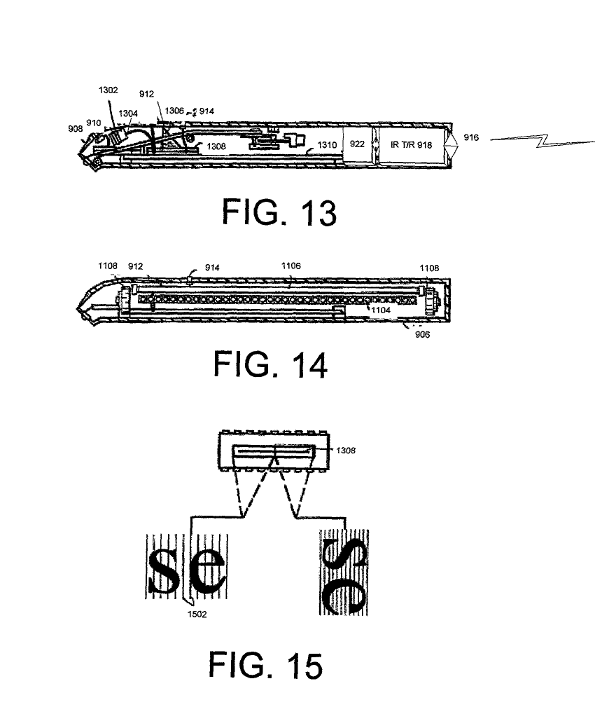

Referring now to FIG. 13, the optics for the character-by-character scanner and the impulse radio interface and impulse radio transmitter or transceiver shall be described in greater detail. A pair of lights 910 which may be LED's are located on the top front-end of the scanner for shining light through the opening 908 onto the surface. Light reflected from the surface is viewed through optical lens 1302. Lens 1302 may be multi-element lens that permits variable magnification. A motor 1304 is provided for adjusting the lens 1302 to vary its magnification. The motor 1304 is electrically connected to a circuit board 1310 which includes the circuitry for controlling the operation of the motor in response to user inputs either from the control buttons or through the host computer. Communicating with circuit board 1310 is impulse radio interface 922 which obtains the scanned information and ensures it is in the appropriate impulse radio format as described above and in the patents and patent applications incorporated herein by reference. The impulse radio interface passes the digital information to impulse radio transmitter/transceiver 918 for transmission to the computer via impulse radio antenna 916.

The area of view on the surface may be separately focused to produce two images of the same area. In accordance with an embodiment of the present invention, an image splitter receives the focused image to then produces two separate images. Image splitter 1306 is illustrated in FIG. 13 as a prism for illustration purposes. Conventional optical image splitters appropriate for carrying out the functions of the present invention may be inserted in the scanner to achieve the objects and functions of the invention. A first image produced by the image splitter 1306 is projected on a detector 1308. The projection of the first image may be arranged on half of detector 1308. The other half of detector 1308 may be for the second image from the image splitter 1306. Alternatively, a first detector may be included for receiving the first image and a second detector may be included for receiving the second image. Image splitter 1306 preferably rotates the first image to produce the second image. The image is preferably rotated 90 degrees. Thus, in the first image vertical slices are taken through the characters being scanned as shown in FIG. 15. The rotated image projected on detector 1308 causes a horizontal slice to be taken through the characters. Accommodation is made in the optics and the software to index the horizontal slices all the way across each of the characters. The pixel information obtained in the vertical slices and the horizontal slices differs enough so that the two sets of information can both be used by character recognition software in the host computer to more accurately identify each of the characters.

It has been found that breaking the character up into horizontal lines often provides more reliable character recognition. The host computer may be provided with two different character recognition software programs running concurrently. Each program can be instructed to analyze each of the two images resulting in four determinations that can be compared to arrive at the most likely correct identification for each character. If most methods provide the same character, then that character is used. If one or more methods could recognize a character, while the other methods could not, then the recognized character is used. If the methods provide different characters, then the processor compares the strings of characters developed by the methods. For instance, one method may provide the string of characters “dog,” while another method provides the string “doy.” Both strings are compared to a list of known words, much like the spell-check feature of a word processor, and the string that matches a known word, e.g., “dog,” is selected.

Referring now to FIG. 14, the line-by-line scanner 1102 is shown positioned within the scanner housing 906. The line-by-line scanner is shown with a linear array of photodiodes as the light detector. Alternatively, the line-by-line scanner may be provided with optical means for focusing the image viewed by the scanner onto an optical detector. For example, it may be possible to focus the image onto a detector so that only a single detector may be shared by both the character scanner and the line scanner.

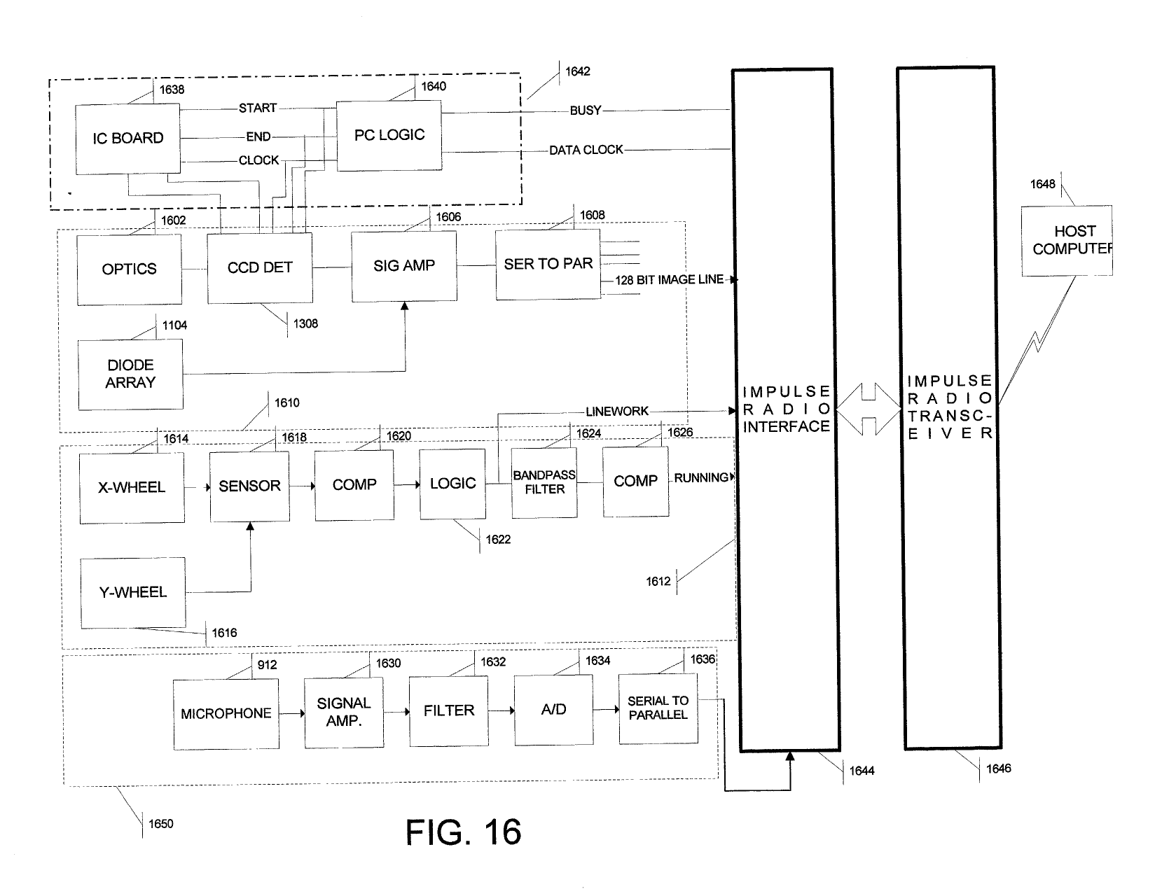

FIG. 16 is a functional block diagram of the major components of the scanner 1102. The major elements include the light intensity measurement system 1610, the movement detection system 1612, the sound detection system 1650 and the control and synchronization system 1642. The light intensity measurement system includes the optics 1602, the optical detector 1308, the photodiode array detectors 1104, a signal amplifier and an output TTL comparator 1604, and a serial to parallel converter 1608. The movement detection system includes an X-wheel 1614 and a Y-wheel 1616. These wheels are rotated by the movement of the ball 1202 in the manner typical of a computer mouse. Movement detection system further includes a movement sensor 1618 associated with each of the X and Y wheels, a wheel sensor comparator 1620 for each wheel, wheel sensor logic 1622, a band pass filter 1624 and a second wheel sensor comparator 1626. The sound detector system includes the microphone 912, a signal amplifier 1630, and a serial to parallel converter 1636. The control and synchronization system includes an IC board 1638, a video/pc logic 1640 and a digital impulse radio interface 1644 in communication with impulse radio transceiver 1646, and a host computer 1648 with an impulse radio interface and impulse radio transceiver located therein (not shown). Each of these systems will now be discussed in turn.

The detector 1308 can be an EG&G CCD array in the presently preferred embodiment with 128 pixels covering 0.25 inch (0.635 cm.). In a preferred embodiment, a first 64 pixels is used to detect a first image and a second 64 pixels is used for detecting a second image obtained from the image splitter. The output from the detector 1308 is amplified and fed into a comparator 1606 and then a serial-to-parallel converter 1608. A field stop is used to limit the image projected onto the detector.

An IC board 1638 can have a “boxcar” style output. A signal amplifier is located on the IC board 1638, within the housing to insure good electronic transmission. The IC board 1638 provides the proper voltages and control signals for the CCD detector 1308, generates clock phases and amplifies and translates the CCD output signal. The output of the IC board 1638 consists of three control signals, namely, a pixel clock, a start of frame signal and an end of frame signal, and one analog signal which is the sampled and held CCD output byte. After a start of frame (and before the end of frame), the analog output is sampled on the rising edge of the pixel clock to insure accurate data. This same IC board can be connected to control the photodiode array 1104 in the wide scanner in addition to the character scanner.

The output TTL comparator is used to convert each sampled and held analog signal from the IC board into a binary indication of light. The comparator has an adjustably settable threshold.

The output of the comparator is a TTL compatible serial data stream, a stream of 128 pixels out of the CCD array. These bytes contain the data from the viewed image.

Sixteen serial in/parallel out shift registers are used to capture this data stream. The serial bytes are clocked with a gated pixel clock which is only active between a start of frame and an end of frame, and corresponds to one clock every other pixel. The parallel output of the serial to parallel converter is used as the digital data for the software.

Each of the X-wheels and Y-wheels frictionally engage the ball 1202. Movement of the scanner normal to the elongate housing is detected by the X-wheel 1614. Movement orthogonal to the X-wheel direction is detected by the Y-wheel 1616. This is the conventional arrangement for a computer mouse. When the scanner is in a character-by-character scanner mode, only the X-wheel is providing information that is used and passed along by the system. The data from the Y-wheel is switched off.

The wheel sensor 1618 output is used to synchronize scanning at predetermined intervals along the character string. The output of the sensor 1618 is used to initiate scans at intersection lines 1502 along the character string as shown in FIG. 15. When the scanner is moved across the surface of the surface so that the X-wheel rotates and the wheel sensor detects the rotation, then comparator 1620 and logic 1622 generate a square wave. A differential amplifier, not shown, but located between the sensor 1618 and the comparator 1620, amplifies the wheel sensor's output to generate a signal large enough to drive wheel sensor comparator 1620. The wheel sensor comparator uses hysteresis to detect pulses from the wheel's sensor, translates these pulses into fixed amplitude pulses and toggles a flip-flop to provide a 50% duty cycle signal, or square wave. A change of state of this square wave indicates a displacement of the scanner across the surface of 1/30th of an inch (0.0847 cm.). The square wave is further filtered by a band pass filter 1624 (high pass filtered, rectified then low-pass filtered) to yield a signal that is fed into a second wheel sensor comparator 1626 to detect motion and generate a RUNNING signal. As shown in FIG. 16, this process yields LINEWORK which triggers a RUNNING signal. These signals are fed via the wireless transmitter or a cable into the host computer and are used by the host computer software to generate data clock signals which control the timing of scanning via the IC board 1638 to correspond to the intersection lines 1502 of FIG. 15.

A microphone 912 receives sound signals when it is activated and converts them into electrical signals. A signal amplifier 1630 prepares the signals for processing. The signals are processed in a conventional manner in order to provide a digitized recording of the sound detected by the microphone 912. In FIG. 16, filter 1632 and A/D converter 1634 are representative of the conventional sound processing components. The digitized sound signal is passed through a serial to parallel converter 1636 then to the impulse radio interface 1644, which communicates with impulse radio wireless transmitter/receiver 1646. The impulse radio wireless transmitter/receiver 1646 is used to communicate back and forth with the computer. It is reiterated the benefits of using impulse radio in lieu of alternate wireless or wired techniques. These include, as mentioned above and in the patents and patent applications incorporated herein by reference, multipath immunity, inherent range determination, lower transmit power and higher bandwidth potential.

The digitized sound may be used by the computer as a recording which may be played back or alternatively voice recognition capability may be implemented by the computer to convert the digitized sound into an ASCII text file.

An off-the shelf digital I/O board, located within the host computer, is connected to an impulse radio interface which receives digital information from impulse radio transmitter/receiver (not shown) and is used to accept the digital data from the movement sensor, optical system and sound system. The basic software in the host computer detects motion by monitoring the RUNNING signal. When the RUNNING signal is active, the pen is moving and scans are initiated. Software in the host computer monitors the BUSY signal from the PC logic 1640. To determine when to upload the contents of the image buffers in the serial-to-parallel converter 1608. When the BUSY becomes inactive, the software uploads the data via impulse radio means. This data includes the binary image, as well as the speed sensor SYNCH signal. Typically, data will be read at a rate faster than 300 frames per inch (118 frames per cm.), although the SYNCH signal will only signal 1/30th of an inch (0.0847 cm.).

Software in the host computer processes the raw data for storage or display by the host computer. For every change in the SYNCH signal (representing 1/30th of an inch or 0.0847 cm.), the software compresses the data such that there are 10 frames worth of data for each SYNCH transition (1/300th of an inch or 0.00847 cm.). This off-line processing yields the required resolution of 1/300th inch (0.00847 cm.), without requiring a speed sensor with so fine a grain.

Once the raw data has been compressed, and perhaps displayed, the software can perform additional data compression for storage to disc.

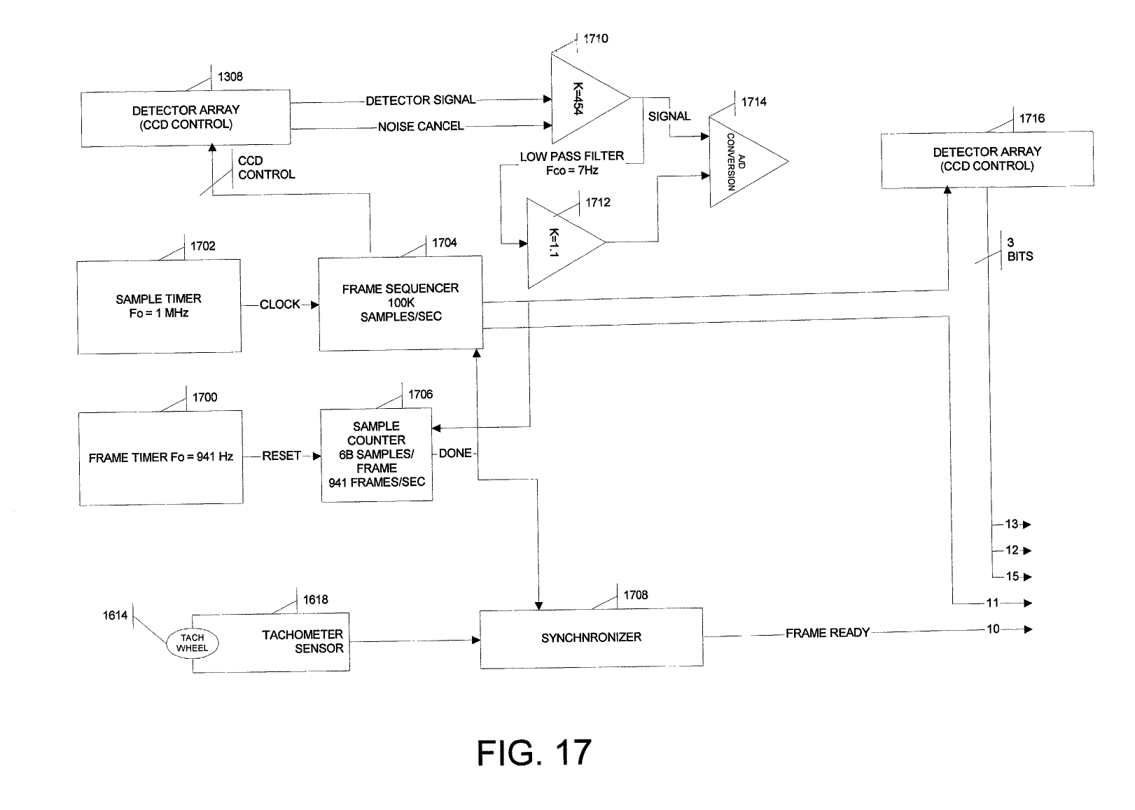

Referring now to FIG. 17, an alternative scheme for controlling the collection of image data is shown. A frame timer 1700 issues clock signals at the presently preferred rate of 941 Hz to set an initial rate at which frames are sampled. A sample timer 1702 generates a clock signal at the presently preferred rate of 1 MHz. This signal is divided down in a frame sequencer 1704 to a presently preferred rate of 100 KHz. The frame sequencer 1704 is used to time the sequential release of signals from the detector array 1308. A sample clock output signal from the frame sequences is provided to a sample counter 1706. The sample counter 1706 also receives the frame clock from the frame timer 1700. The sample counter combines these signals to periodically issue a DONE signal. The DONE signal is combined with the output of the X-wheel sensor 1618 in a synchronizer 1708. The synchronizer 1708 issues a frame ready signal for each frame of bits that are to be sent to the host computer.

The bits output from the detector array 1308 are analog signals. They are amplified by amplifier 1710. A low pass filter 1712 is used to set a threshold. The threshold is used in a comparator 1714 to determine individually for each bit whether it is black or not black. The threshold setting filter 1712 essentially averages the values of the bits over many samples and increases the average by about ten percent to set the threshold. The comparator 17 issues a digital signal for each bit. The bits are collected three at a time in a buffer 1716 for delivery to the host computer. A data ready signal from the frame sequences 1704 and a frame ready signal from synchronizer 1708 are used to control the orderly delivery of the bits in the buffer 1716 to the host computer. Several bits at the beginning and the end of each frame are used to indicate the beginning or end rather than to represent a pixel.

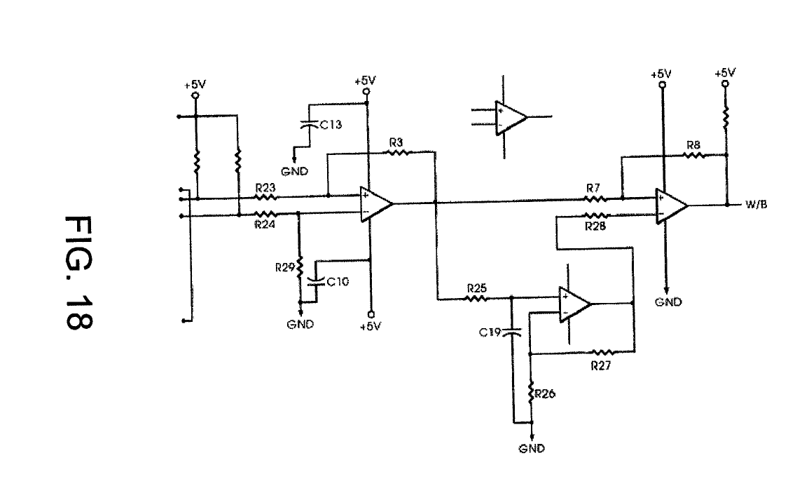

Referring now to FIG. 18, a threshold setting circuit and comparator is shown in greater detail. This is only one of a variety of circuits that may be designed for achieving the same purposes and functions as described as follows. Using an analog switch, we take a sample right at the detector 1308. When the switch is turned on, the sample is run into a capacitor. The capacitor holds it. Continually dumping pixels into the capacitor, the capacitor then creates an average. The pixels for a vertical line are determined by reading all 64 pixels over several vertical lines. We take an average of all the dark pixels in the line. This is done over several lines. Thus an average is also spread over a number of lines. Then by reducing the average slightly, we create a threshold. If a pixel has a darkness level to one side of the threshold, it is seen as black, when the pixel is on the other side of the threshold, it is seen as white. The threshold is continually updated as the value of an average dark pixel, or alternatively an average white pixel, changes over a series of lines. By providing a variable threshold, the present invention accommodates for the variation in print darkness that can especially be encountered in newspapers. Each pixel is individually compared to the threshold to produce a white or black bit.

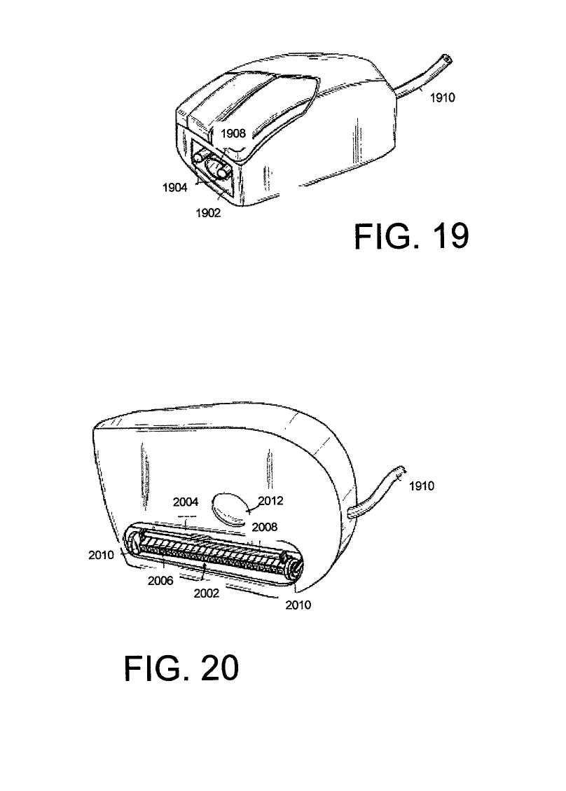

FIGS. 19 and 20 show an alternative embodiment of the invention, wherein the character-by-character scanner and line-by-line scanner are incorporated into a standard mouse housing. The window or opening 1902 through which the character scanner reads the characters on the surface may be located at any convenient point around the perimeter of the mouse, and is shown in FIG. 19 as being mounted at the front of the mouse. The lights 1904 and the lens 1908 are arranged behind the window or opening 1902 for viewing an area in front of the mouse/scanner. This arrangement permits scanning with the user's hand in the same position on the mouse as during normal use of the mouse, and permits scanning of a line of characters without obstructing the user's view of any portion of the line, i.e., an “underlining” motion. As with the elongate housing version of the scanner, the mouse/scanner may be provided with a microphone, a threshold setting circuit, an image splitter, a wireless transmitter/receiver and/or a variable magnification lens.

A line-by-line scanner 2002 may be mounted on the bottom side of the mouse housing. The bottom side of the mouse housing also accommodates the mouse ball 2012 as in a standard computer mouse. A sliding door 2004 may be provided to cover the line-by-line scanner 2002 when not in use. The door 2004 is mounted so that it can slide over to reveal the scanner. The scanner is provided with a pair of encoder wheels 2010 that are spring mounted. When the door 2004 is slid out of the way, the wheels emerge so as to provide movement data. The scanner itself includes a light source 2008 and a photodiode array 2006.

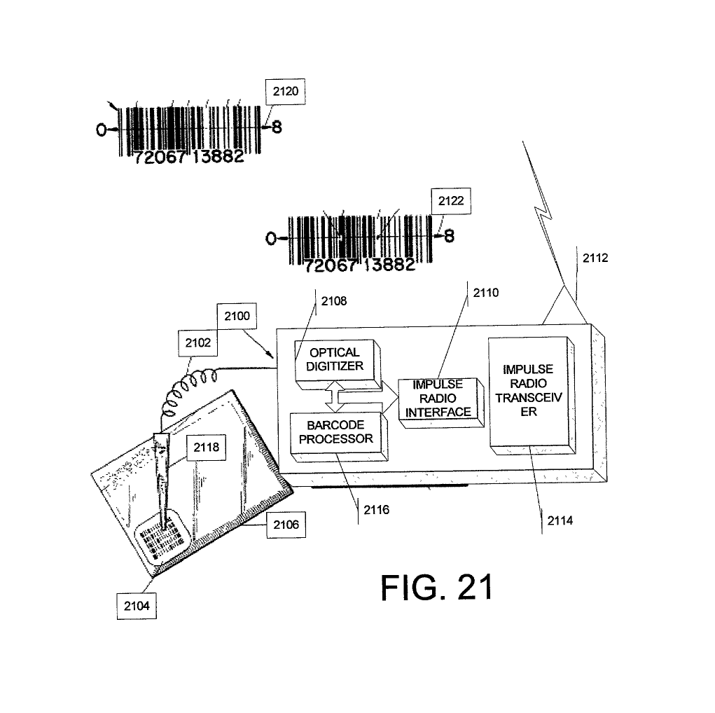

FIG. 21 illustrates the present invention in a bar code scanner environment. Much as with the text scanner, the information from bar code scanner assimilate information and then pass that information to a remote device through the use of impulse radio techniques. As shown in FIG. 21, handheld scanner 2118 scans bar code 2104 (shown enlarged at 2120 and 2122) that can be placed on a package 2106 or other item of interest to provide information about the package. Shown at 2100 are the basic components of the scanner and impulse radio incorporated therein. Included are optical digitizer 2108 and bar code processor 2116. These elements enable the information extraction from the bar code and therefore the package. Also included for the impulse radio wireless transmission are impulse radio interface 2110 and impulse radio transceiver 2114 (which can be simply a transmitter depending on the needs of the user) Impulse radio antenna 2112 is connected the impulse radio transceiver 2112 and provides transmission through the ether. More specific information on the scanner components and its use outside of the impulse radio environment can be found in U.S. Pat. No. 4,728,784 entitled, “Apparatus and method of encoding and decoding barcodes”. Further details of the impulse radio implementation can be found above and in the patents and patent applications incorporated herein by reference.

While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements which embody the spirit and scope of the present invention.

What is claimed is:

1. A hand-held scanner with an impulse radio wireless interface comprising:
a housing having an elongate shape with a scanning end and a rear end;
optical detector means, located within said housing, for detecting relative intensity of light reflected from a surface, said surface may contain characters or symbols thereon;
an impulse radio interface, interfacing with said optical detector means and in communication with an impulse radio transmitter, wherein said impulse radio transmitter transmits scanned information to a remote location by impulse radio means.

2. The hand-held scanner with an impulse radio wireless interface of claim 1, further comprising a recording means associated with said hand-held scanner for recording voice information for transmission via impulse radio means.

3. The hand-held scanner with an impulse radio wireless interface of claim 1, wherein said remote location is a remote computer.

4. The hand-held scanner with an impulse radio wireless interface of claim 3, wherein said remote computer includes an impulse radio transceiver for receiving the scanned information from said hand-held scanner by impulse radio means.

5. The hand-scanner of claim 1, further comprising a comparator coupled to said optical detector means for receiving signals corresponding to the relative intensity of light from said optical detector means to determine whether each such signal is above or below an intensity threshold and means for setting the intensity threshold responsive to the relative intensities of points in an area of view being scanned.

6. The hand-held scanner of claim 1, further comprising an image splitter for producing two images of a first area of view, said two images being rotated with respect to each other and for providing said two images to said optical detector means.

7. The hand-held scanner of claim 1, further comprising means for adjusting the magnification of said first optical means and thereby change the size of the first area of view.

8. The hand-held scanner of claim 1, further comprising first movement means, mounted proximate the scanning end of said housing, for detecting movement of the scanner across a surface when the scanning end of said housing is moved along a line of characters to read the characters through the first area of view.

9. The hand-held scanner of claim 8, further comprising second movement means, mounted on the side of said housing, for detecting movement of the scanner across the substrate when the side of said housing is moved over a surface line by line to read the characters through the second area of view.

10. The hand-held scanner of claim 1, wherein said optical detector means comprises a CCD array for detecting light from a plurality of points in the first area of view and a photodiode array for detecting light from a plurality of points in the second area of view.

11. The hand-held scanner of claim 1, wherein the impulse radio determines the distance between the hand-held scanner and remote device using impulse radio distance determine techniques.

12. The hand-held scanner of claim 11, wherein subsequent to said distance determination, the data rate is modified according to the distance determination.

13. The hand-held scanner of claim 1, wherein the scanner gives warning that the scanner is out of range of the remote device based on distance determination determined by impulse radio distance determining techniques.

14. A package information assimilation system, comprising:
a scanner, said scanner comprising an optical digitizer for detecting line bar codes from a surface and a bar code processor for interpreting the output of said digitizer; and
an impulse radio interface interfacing with said bar code processor in communication with an impulse radio transmitter for transmitting by impulse radio means the output of said bar code processor.

15. The package information assimilation system of claim 14, further comprising a remote processing and storage device including an impulse radio receiver in impulse radio communications with said impulse radio transmitter of said scanner.

16. The package information assimilation system of claim 14, further comprising means for adjusting the magnification of said optical digitizer and thereby change the size of a first area of view.

17. The package information assimilation system of claim 14, further comprising first movement means, mounted proximate the scanning end of said housing, for detecting movement of the scanner across a surface when the scanning end of said housing is moved along a line bar codes to read the bar codes through the first area of view.

18. The package information assimilation system of claim 14, wherein said optical detector means comprises a CCD array for detecting light from a plurality of points in the first area of view and a photodiode array for detecting light from a plurality of points in the second area of view.

19. The package information assimilation system of claim 14, wherein the impulse radios determine the distance between the hand-held scanner and remote device using impulse radio distance determination means.

20. The package information assimilation system of claim 19, wherein subsequent to the distance determination, the data rate is modified according to said distance determination.

21. The hand-held scanner of claim 19, wherein said scanner gives warning that said scanner is out of range of said remote device based on distance determination determined by impulse radio distance determining techniques.

22. A method of bar code information assimilation, comprising the steps of:
scanning a bar code with a bar code scanner;
obtaining information contained within said bar code; and
transmitting said bar code information to a remote location by impulse radio means.

23. The method of bar code information assimilation of claim 22, wherein said remote location is a remote computer.

24. The method of bar code information assimilation of claim 23, wherein said remote computer includes an impulse radio receiver for receiving impulse radio transmissions from said bar code scanner.

25. The method of bar code information assimilation of claim 23, further comprising the step of determining the distance from said bar code scanner and said remote computer by impulse radio techniques.

26. The method of bar code information assimilation of claim 23, further comprising the step of varying the data rate according to said distance determined from said bar code scanner and said remote computer.

27. The method of bar code information assimilation of claim 23, further comprising the step of warning the user of said bar code scanner that said bar code scanner is out of range of said remote computer.

28. A method of scanning text information from a hand-held scanner, comprising the steps of:
scanning text with a hand-held scanner, said hand held scanner including an impulse radio interface and an impulse radio transmitter therein; and
transmitting said text information to a remote location by impulse radio means.

29. The method of bar code information assimilation of claim 28, wherein said remote computer includes an impulse radio receiver for receiving impulse radio transmissions from said impulse radio scanner.

30. The method of bar code information assimilation of claim 29, further comprising the step of determining the distance from said bar code scanner and said remote computer by impulse radio techniques.

31. The method of bar code information assimilation of claim 30, further comprising the step of varying the data rate according to said distance determined from said bar code scanner and said remote computer.

32. The method of bar code information assimilation of claim 31, further comprising the step of warning a user of said bar code scanner that said bar code scanner is out of range of said remote computer.

33. A computer program product comprising a computer readable medium having computer program code, for executing scanning and impulse radio transmissions, said product including:
conversion process procedure codes for obtaining text information from a scanning device and converting said text or bar code information into digital information for transmission by impulse radio wireless techniques to a remote computer; and
transmission process procedure codes for transmitting by impulse radio means the scanned and converted digital information.

34. The computer program product of claim 33, further comprising impulse radio distance determination codes for determining the distance between said scanning device and said remote computer.

35. The computer program product of claim 34, further comprising codes that use the distance determination by impulse radio means and vary the data rate of the wireless transmission based on the distance from said scanning device to said remote computer.

36. The computer program product of claim 34, further comprising codes that initiate a warning when the distance determined by impulse radio distance determination techniques from said scanning device to said remote computer exceed a predetermined limit.
